(19) United States
(12) Patent Application Publication
(10) Pub. No.: US 2024/0206411 A1
(43) Pub. Date: Jun. 27, 2024

(54) Hydroponic Cultivation System and Grow Tower

(71) Applicant: Produced Incorporated, Atlanta, GA (US)

(72) Inventor: Greg Crafter, Atlanta, GA (US)

(21) Appl. No.: 18/392,774

(22) Filed: Dec. 21, 2023

Related U.S. Application Data
(60) Provisional application No. 63/476,674, filed on Dec. 22, 2022.

(51) Int. Cl. A01G 31/06; A01G 27/00

(52) U.S. Cl. CPC A01G 31/06; A01G 27/006

(57) ABSTRACT

A tower arrangement for plant cultivation includes at least one tower unit with two sides at an obtuse angle relative to each other. Each side provides a single vertical column configured to receive pods that are adapted to contain plants. Each pod is installed through an opening at an incline, or acute angle, relative to the vertical surface of the sides of the tower.

### CROSS REFERENCE

The present application relies on U.S. Patent Provisional Application No. 63/476,674, titled “Hydroponic Cultivation System and Grow Tower” and filed on Dec. 22, 2022, for priority, which is herein incorporated by reference in its entirety.

### FIELD

The present specification relates to assemblies and methods for hydroponic plant tower arrangements.

### BACKGROUND

Individuals and commercial spaces, including restaurants, increasingly have an interest in growing their own food. Hydroponic plant production systems and methods provide for manual and automated arrangements that grow plants without the need for soil and soil-based nutrients. These systems use water, nutrients, and artificial and/or natural light to nourish the plants.

Traditional hydroponic growing systems include horizontally positioned pots that contain plants which are nourished using either a static solution or through a continuous-flow solution. However, these systems consume a lot of space owing to their horizontal spread. Vertical tower arrangements have been introduced as a compact growing system that requires little space. The towers include vertically arranged pots that are used for planting hydroponic plants.

What is needed are tower arrangements for creating indoor gardens that can sustainably grow food at a higher yield and with a smaller footprint.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses a system for plant cultivation in a vertical arrangement, the system comprising: at least one vertical tower made from a first material, comprising: a first wall; a second wall in continuation with and at an obtuse angle to the first wall; spaced multiple openings vertically aligned in a single column on each of the first wall and second wall, wherein the multiple openings on the second wall are staggered relative to the multiple openings on the first wall; a plurality of pods wherein each of the plurality of pods is configured to hold a grow block adapted to cultivate a plant, wherein each of the plurality of pods is configured to be inserted into one of the spaced multiple openings, and wherein each pod of the plurality of pods is oriented at an acute angle relative to the at least one vertical tower.

Optionally, the first material is steel. Optionally, the first material is a metal.

Optionally, the spaced multiple openings are equally spaced.

Optionally, the system further comprises a frame comprising: a first side structure and a second side structure; a top shelf fitted between, and at the top of, the first side structure and the second side structure, wherein the top shelf comprises at least two magnetic brackets configured to couple to the at least one vertical tower; a base box fitted between, and at the bottom of, the first side structure and the second side structure, the base box comprising: a water reservoir; and a pump, wherein the at least one tower is positioned within the frame between the first side structure and the second side structure, below the top shelf, and above the base box.

Optionally, the first side structure and the second side structure comprise at least one light coupled to each of the first side structure and the second side structure.

Optionally, the at least one tower comprises a tubing configured to carry water pumped by the pump from the water reservoir up to a top side of the at least one tower. Optionally, the tubing at the top of the at least one tower branches into at least two smaller tubes, wherein one of the at least two smaller tubes is configured to distribute the water from the tubing to the first wall and, wherein a second one of the at least two smaller tubes is configured to distribute the water from the tubing to the second wall. Optionally, said distribution of water to the first wall and the second wall occurs concurrently.

Optionally, the system further comprises a drain positioned at a bottom of the at least one tower, wherein the drain is located above the base box and is configured to open into the water reservoir.

Optionally, the base box further comprises a housing comprising electrical components, wherein the housing is attached to a bottom side of the base box.

The present specification also discloses a method for assembling a vertical arrangement for plant cultivation, the method comprising: attaching a frame comprising a first side structure and a second side structure, to a base box which is fixed between, and at the bottom of, the first side structure and the second side structure, wherein the base box comprises a water reservoir, a pump, and a housing comprising electrical components that are electrically connected to the pump; fitting a top shelf between and at the top of, the first side structure and the second side structure; positioning at least one tower within the frame between the first side structure and the second side structure, below the top shelf, and above the base box, each of the at least one tower comprising: a first wall; a second wall in continuation with and at an obtuse angle to the first wall; spaced multiple openings vertically aligned in a single column on each of the first side and second side, wherein the multiple openings on the second side are staggered relative to the multiple openings on the first side; inserting a pod into each of the spaced multiple openings, wherein each pod is configured to hold a grow block adapted to cultivate a plant, and wherein each pod of the plurality of pods is oriented at an acute angle relative to the at least one tower.

Optionally, the method comprises using screws for the assembling.

Optionally, the base box is fixed in a horizontal plane above the ground level, allowing some space between the bottom surface of the base box and the ground surface.

Optionally, the top shelf comprises a vertical shelf panel, wherein a top horizontal edge of the vertical shelf panel is aligned between top rear corners of the first and the second side structures.

Optionally, the method further comprises positioning an intermediate structure comprising the frame, the base box without the reservoir and the pump, and the top shelf, on a wall. Optionally, the method further comprises positioning the reservoir towards a rear side inside the base box. Optionally, the method further comprises placing a pump inside the reservoir. Optionally, the method further comprises fixing the pump to an internal bottom surface of the reservoir using suction cups. Optionally, the method further comprises installing a reservoir lid over the reservoir.

Optionally, positioning the at least one tower comprises placing a bottom edge of the at least one tower over at least one drain fitted above at least one cutout within the reservoir.

Optionally, the method further comprises: tilting a top edge of the at least one tower unit at an angle while positioning a bottom edge of the tower unit into the at least one drain; and straightening the top edge until two strike plates on a back side of the at least one tower magnetically clasps to an underside of a horizontal shelf panel of the top shelf.

Optionally, the method further comprises securing lights on each of the first side and the second side of the frame.

Optionally, the method further comprises adding water to the reservoir.

Optionally, the method further comprises enabling power supply to operate the vertical arrangement, comprising connecting the electrical components to a power source.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 is an exploded view of a two-tower assembly in accordance with some embodiments of the present specification;

FIG. 2A illustrates an exemplary embodiment of a front view of a single tower in accordance with the present specification;

FIG. 2B illustrates a side of the single tower of FIG. 2A in accordance with an embodiment of the present specification;

FIG. 2C shows a back panel, positioned at a rear side of the tower shown in FIG. 2A in accordance with an embodiment of the present specification;

FIG. 2D is a rear internal view of the single tower of FIG. 2A, which is typically not visible due to the presence of a back panel (shown in FIG. 2C), in accordance with an embodiment of the present specification;

FIG. 3A shows an exemplary sheet of stainless steel with dashed lines that mark the locations of the folds created on the sheet to fabricate a tower, in accordance with some embodiments of the present specification;

FIG. 3B is a front view of a tower fabricated after folding the stainless-steel sheet of FIG. 3A as per the illustrated specifications, in accordance with the embodiments;

FIG. 3C is a top view of the folded sheet of FIG. 3A, in accordance with some embodiments of the present specification;

FIG. 4A is a rear view of a pod in accordance with an embodiment of the present specification;

FIG. 4B illustrates a rear side of the pod of FIG. 4A in accordance with an embodiment of the present specification;

FIG. 4C is a front view of the pod of FIG. 4A in accordance with an embodiment of the present specification;

FIG. 4D is a top view of the pod of FIG. 4A in accordance with an embodiment of the present specification;

FIG. 4E illustrates a bottom view of the pod of FIG. 4A in accordance with an embodiment of the present specification;

FIG. 4F is a perspective view of the pod of FIG. 4A in accordance with an embodiment of the present specification;

FIG. 5A is a top perspective view of lid assembly in accordance with some embodiments of the present specification;

FIG. 5B shows both a top view and a side elevation view of the lid assembly of FIG. 5A;

FIG. 5C illustrates exemplary dimensions of the lid assembly and the positions and dimensions of grommets in accordance with an embodiment of lid assembly of FIG. 5A;

FIG. 6A is a front view of a pod bezel in accordance with some embodiments of the present specification;

FIG. 6B is a side elevated view of pod bezel or housing of FIG. 6A;

FIG. 6C is a rear side view of pod bezel or housing of FIG. 6A;

FIG. 7A shows a top surface of a lid that may be used to cover a pod in accordance with some embodiments of the present specification;

FIG. 7B is a side view of the lid of FIG. 7A;

FIG. 7C is a view of the bottom surface of the lid of FIG. 7A;

FIG. 7D is a bottom side perspective view of the lid of FIG. 7A;

FIG. 8 illustrates an orientation of a pod positioned for insertion into an opening of the tower, in accordance with some embodiments of the present specification;

FIG. 9 illustrates the orientation of a pod positioned relative to the tower orientation while inserting into a tower opening, in accordance with some embodiments of the present specification;

FIG. 10A is an outer view of a side structure in accordance with some embodiments of the present specification;

FIG. 10B is a front view of a side structure in accordance with some embodiments of the present specification;

FIG. 10C is an inner view of a side structure (a side which faces each tower unit) in accordance with some embodiments of the present specification;

FIG. 10D is a side perspective view of a side structure in accordance with some embodiments of the present specification;

FIG. 11A is an outer side view of a front vertical portion in accordance with some embodiments of the present specification;

FIG. 11B is a front view of a vertical portion in accordance with some embodiments of the present specification;

FIG. 11C is an inner side view of a front vertical portion in accordance with some embodiments of the present specification;

FIG. 11D is a front, side perspective view of a front vertical portion in accordance with some embodiments of the present specification;

FIG. 12A is a front view of a horizontal portion in accordance with some embodiments of the present specification;

FIG. 12B is a side view of a horizontal portion in accordance with some embodiments of the present specification;

FIG. 12C is a bottom view of a horizontal portion in accordance with some embodiments of the present specification;

FIG. 12D is a rear view of horizontal portion shown in FIG. 12A in accordance with some embodiments of the present specification;

FIG. 13A is a front side view of the top shelf in accordance with some embodiments of the present specification;

FIG. 13B is a rear side view of the top shelf in accordance with some embodiments of the present specification;

FIG. 13C is a side view of the top shelf in accordance with some embodiments of the present specification;

FIG. 13D is an exploded view of a magnetic catch assembly on a bottom surface of the top shelf in accordance with some embodiments of the present specification;

FIG. 14A is a top view of a horizontal panel in accordance with some embodiments of the present specification;

FIG. 14B is a side view of a horizontal panel in accordance with some embodiments of the present specification;

FIG. 14C is a bottom view of a horizontal panel in accordance with some embodiments of the present specification;

FIG. 15A is a front view of a vertical panel in accordance with some embodiments of the present specification;

FIG. 15B is a side view of a vertical panel in accordance with some embodiments of the present specification;

FIG. 15C is a rear view of a vertical panel in accordance with some embodiments of the present specification;

FIG. 16A is a front view of a wall spacer in accordance with some embodiments of the present specification;

FIG. 16B is a side view of a wall spacer in accordance with some embodiments of the present specification;

FIG. 16C is a rear view of a wall spacer in accordance with some embodiments of the present specification;

FIG. 17A is a top side view of a base box in accordance with some embodiments of the present specification;

FIG. 17B is a view of the right side of the base box of FIG. 17A, in accordance with some embodiments of the present specification;

FIG. 17C is a front side view of the base box of FIG. 17A, in accordance with some embodiments of the present specification;

FIG. 17D is a back side view of the base box of FIG. 17A, in accordance with some embodiments of the present specification;

FIG. 17E is a perspective view of the base box of FIG. 17A, in accordance with some embodiments of the present specification;

FIG. 18A is a top-down view of a top panel in accordance with some embodiments of the present specification;

FIG. 18B illustrates a view from the right edge of the top panel of FIG. 18A in accordance with some embodiments of the present specification;

FIG. 19A is a front view of a rectangular left side panel in accordance with some embodiments of the present specification;

FIG. 19B is a view of a right-side edge of the left side panel of FIG. 19A in accordance with some embodiments of the present specification;

FIG. 20A is a front view of a rectangular front panel in accordance with some embodiments of the present specification;

FIG. 20B is a right-side edge view of the front panel of FIG. 20A in accordance with some embodiments of the present specification;

FIG. 21A is a front view of rectangular back panel in accordance with some embodiments of the present specification;

FIG. 21B is a right-side edge view of the rectangular back panel of FIG. 21A in accordance with some embodiments of the present specification;

FIG. 22A is a top view of a bottom panel in accordance with some embodiments of the present specification;

FIG. 22B is a view from the right side of bottom panel of FIG. 22A in accordance with some embodiments of the present specification;

FIG. 22C is a bottom-up view of the bottom panel in accordance with some embodiments of the present specification;

FIG. 23A is a side view of a tower drain which can be installed on the left side of tower assembly of FIG. 1, in accordance with some embodiments of the present specification;

FIG. 23B is a top view of the tower drain of FIG. 23A in accordance with some embodiments of the present specification;

FIG. 23C is a perspective view of the tower drain of FIG. 23A;

FIG. 24A is a top surface view of a lid panel that is positioned on top of a base box in the same plane as the top panel, in accordance with some embodiments of the present specification;

FIG. 24B is a side view of the lid panel of FIG. 24A in accordance with some embodiments of the present specification;

FIG. 24C is a bottom surface view of the lid panel of FIG. 24A in accordance with some embodiments of the present specification;

FIG. 25A is a top view of an oval-shaped fill port that is sized to fit and outline the opening in lid panel of FIG. 24A, in accordance with some embodiments of the present specification;

FIG. 25B is a perspective view of the fill port of FIG. 25A in accordance with some embodiments of the present specification;

FIG. 25C is a longitudinal side view of the fill port of FIG. 25A, in accordance with some embodiments of the present specification;

FIG. 25D illustrates a short-side view of the fill port of FIG. 25A, in accordance with some embodiments of the present specification;

FIG. 26A shows the flow port of FIGS. 26A-26D assembled on the lid panel of FIGS. 24A-24C in accordance with some embodiments of the present specification;

FIG. 26B is a first side view of the flow port of FIG. 26A;

FIG. 26C is a front, side view of the flow port of FIG. 26A;

FIG. 27A is an exploded view of the components of an electrical box in accordance with some embodiments of the present specification;

FIG. 27B is a first side view of the electrical box of FIG. 27A in an assembled state, in accordance with some embodiments of the present specification;

FIG. 27C is a second side view, opposite the first side shown in FIG. 27B, of the electrical box of FIG. 27A in an assembled state, in accordance with some embodiments of the present specification;

FIG. 27D shows an exemplary structure of a receptacle plate in accordance with the present specification;

FIG. 27E is an exploded view of the components of an electrical box in accordance with some alternate embodiments of the present specification;

FIG. 27F is a first side view of electrical box of FIG. 27E in its assembled state, in accordance with some embodiments of the present specification;

FIG. 27G is a second side (opposite to the first side) view of electrical box of FIG. 27E in its assembled state, in accordance with some embodiments of the present specification;

FIG. 28A is an elevation view of an exemplary reed switch used in accordance with some embodiments of the present specification;

FIG. 28B is a top view of the reed switch of FIG. 28A;

FIG. 28C is a cross-sectional view of the reed switch of FIG. 28A;

FIG. 29A is an elongate first view of vine wire in accordance with some embodiments of the present specification;

FIG. 29B is an elongate second view of the vine wire of FIG. 29A, rotated by 90°, in accordance with embodiments of the present specification;

FIG. 30A is a top view of pump assembly in accordance with some embodiments of the present specification;

FIG. 30B is a side elevation view of the pump assembly of FIG. 30A;

FIG. 30C is a front elevation view of the pump assembly of FIG. 30A;

FIG. 30D is a perspective view of the pump assembly of FIG. 30A;

FIG. 31 illustrates an assembly of a reservoir tank fitted with a reservoir lid and positioned inside a base box connected to bottom of a dual tower unit, in accordance with some embodiments of the present specification; and

FIG. 32 is a flow chart illustrating an exemplary process of assembling the vertical arrangement of plant cultivation in accordance with some embodiments of the present specification.

### DETAILED DESCRIPTION

The present specification is directed toward a hydroponic tower arrangement for growing plants. In embodiments, a tower unit is formed by a first vertical wall and a second vertical wall that are configured to be attached at an angle to each other such that a cross-section of the tower unit forms a V shape, with either a sharp or a smooth curvature at the point of attachment. In embodiments, the tower unit is made from stainless steel. In embodiments, the first vertical wall includes a vertical linear arrangement of equally spaced ‘pod bezels’ or slots, wherein each pod bezel is configured to hold a ‘pod’ or cup. Each pod comprises four walls that form an enclosed space to contain a plant—namely, a first side wall parallel to a second side wall; a third back wall configured with a downward slope; and a fourth front wall, opposite to the third wall, that has an upward slope.

In embodiments, the second vertical wall includes a similar vertical linear arrangement of equally spaced pod bezels such that the pod bezels of the second vertical wall are positioned at a staggered distance along a vertical linear axis, from their counterparts of the first vertical wall. The pod bezels are designed such that the pods snap-fit into them. Therefore, the pods are removably attached to the tower using the pod bezels as the attachment mechanism.

In order to use the hydroponic plant system, a user obtains a plant and places the plant into a pod (also referred to as a “cup”). In some embodiments, the pod is uniquely designed to lock into the corresponding pod bezels. In embodiments, one or more plants may be placed into each pod so that roots of the plant(s) extend through the base of the pod. The base of each pod enables the roots to be in fluid communication with a watering and nutrient feeding system that is configured to be positioned into and used with the tower. In embodiments, the water and nutrient feeding system comprises a reservoir containing water and nutrients (hereinafter together referred to as ‘fluid’), a pumping device, a tube, and a network of tubing that carries fluid to the pods. The water and nutrient feeding system is positioned at bottom of the tower. The tubing originates from the bottom of the tower within the water and nutrient feeding system, extends upwards toward the top of the tower, and networks into multiple tubes near the top of the tower. The pumping device feeds the tube that extends to the top of the tower. The tube breaks off into separate tubing and pours over the top of the third back wall of the cups at the top of each vertical wall. The downward slope of the top pods and subsequent pods in the vertical alignment provide for efficient nutrient and water distribution by pouring the fluids over entire length of roots of the plant within each pod. The water and nutrient feeding system may be programmed to periodically pump fluids. In embodiments, a wireless flow water sensor is positioned in a lid of the reservoir. The sensor generates an audio, a visual, or an audio-visual alarm upon sensing a fluid level below a predefined threshold within the reservoir. Once the low fluid level is detected, the pumping device is disabled.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

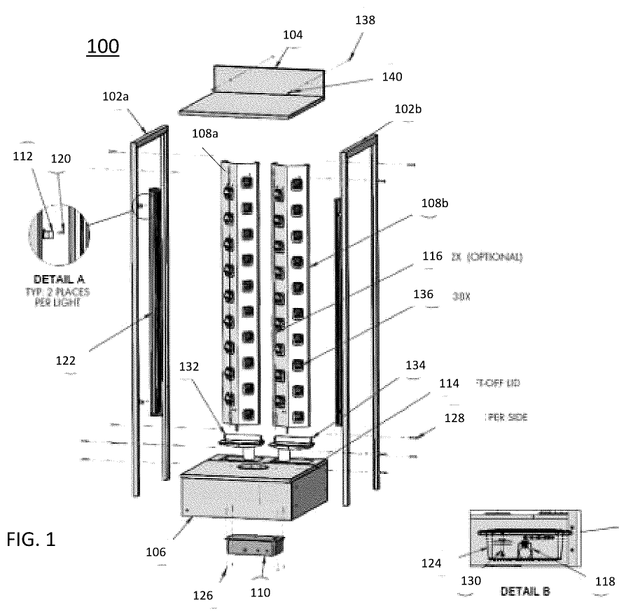

Embodiments of the hydroponic tower assembly in accordance with the present specification are now described. The tower assembly may include one or more tower units. The number of tower units can vary and may be attached (in any number) to the tower assembly using an attachment mechanism, such as a magnetic attachment mechanism, that enables the attachment of additional tower unit(s) and allows for removal of an existing tower unit from the tower assembly. FIG. 1 illustrates an exploded view of a hydroponic tower assembly 100 in which two tower units are employed, in accordance with some embodiments of the present specification. In some embodiments, tower assembly 100 has a length ranging from 12 inches to 32 inches (preferably 25 inches), a width ranging from 12 inches to 32 inches, and has a total height in a range of 16 inches to 78 inches, and preferably a height of approximately 72 inches. FIG. 1 illustrates a first side structure 102a and a second side structure 102b, on opposing sides of assembly 100, wherein each of the first side structure and second side structure comprises an inverted U-shaped frame. A shelf 104 is positioned at the top of assembly 100 and a base box 106 is positioned at the bottom side of assembly 100. FIG. 1 shows two tower units 108 (108a and 108b) that are positioned between the first side structure 102a and second side structure 102b, below top shelf 104, and above base box 106.

In embodiments, each tower unit (such as tower units 108a and 108b) is formed by a first vertical wall and a second vertical wall that are configured to be attached at an angle to each other such that a cross-section of the tower unit forms a V shape, with either a sharp or a smooth curvature at the point of attachment. In embodiments, tower units 108a and 108b are made from stainless steel. In embodiments, the first vertical wall includes a vertical linear arrangement of equally spaced pod bezels, wherein each pod bezel is configured to hold a pod 136 (in the figure, the pod bezels are obscured by the pods 136 that are inserted therein). Each pod 136 comprises four walls that form an enclosed space to contain a plant—namely, a first side wall parallel to a second side wall; a third back wall configured with a downward slope; and a fourth front wall, opposite to the third wall, that has an upward slope. In some embodiments, each tower unit 108 (108a or 108b) includes 19 pod bezels to hold 19 pods, with 10 pods on one vertical wall and 9 on the other vertical wall. In some optional embodiments, a vine wire 116 is included on at least one vertical wall of a tower unit 108. The vine wire 116 may extend from a bottom side, linearly to the top side of the wall. The vine wire 116 may be used by certain types of plants to provide support to grow and climb along the wall.

An electrical box 110 is attached to an outer bottom surface of base box 106 using wooden screws 126. Electrical box 110 comprises electrical components used to control the power supply to operate the various aspects of assembly 100. In some embodiments, at least four screws 126 are used at four corners of a top surface of electrical box 110 so that it can be attached to base box 106.

Detail B shown in FIG. 1 outlines components that may be housed within a housing formed by base box 106. The housing of base box 106 comprises a pump device 118, a tub or reservoir 124 to store fluids, and a reservoir lid assembly 130. The housing is covered on the top side by a lid assembly 114. In some embodiments, lid 114 is a lift-off lid that enables the user to simply raise and/or lift the lid 114 to access contents of base box 106. Top surface of lid 114 is attached to a first tower drain 132 for the left side tower unit 108a and a second tower drain 134 for the right-side tower unit 108b. Each tower drain 132 and 134 is configured with a horizontal portion that fits to the base of corresponding tower units 108a and 108b, respectively. The horizontal portion comprises a hole attached to a vertical pipe that can be inserted through lid 114 and which enables drainage of excess fluids collected from the downflow through the tower units 108a and 108b. Each tower drain 132, 134 is coupled to lid 114 using at least six screws 128.

Further, each side structure, namely, first side structure 102a and second side structure 102b, may include a grow light 122. Therefore, a grow light 122 is attached to the corresponding side structure 102a on the first (left) side, and another grow light 122 is attached to the corresponding second (right) side structure 102b. The grow lights 122 may be attached to the respective side structures 102a and 102b using at least a pair of screws 120 that are inserted using clips 112.

Top shelf assembly 104 comprises a vertical rectangular plate that is parallel to and may be attached to a vertical wall. In some embodiments, a pair of drywall anchors 138 (approximately 1 inch long) are used to attach the vertical rectangular plate to a vertical wall using screws 140. The vertical rectangular plate is continuously attached to a perpendicular plate in a horizontal plane so that each side, specifically, the left side and the right side, of the plate in the horizontal plane (referred to as ‘horizontal plate’) connects to the top edges of first side structure 102a and second side structure 102b, respectively. The vertical rectangular plate is at a back side of assembly 100, while the horizontal plate extends from the back side, where it is joined to the vertical rectangular plate, to the front side.

The components that have been mentioned and described briefly with respect to FIG. 1 will now be described in greater detail.

### Tower Unit

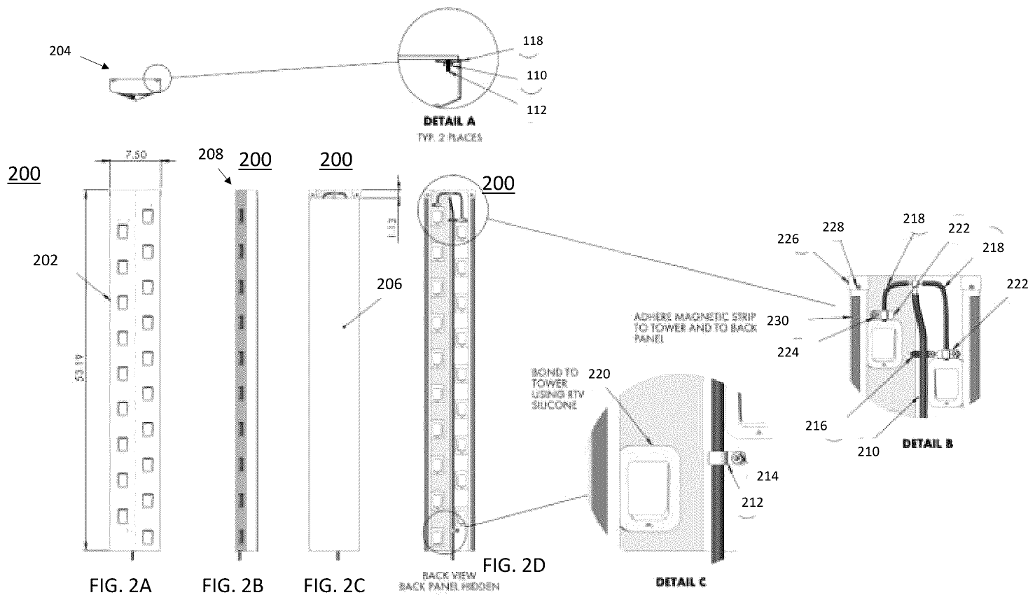

FIG. 2A illustrates an exemplary embodiment of a front view 202 of a tower unit 200 (tower unit 108a/108b shown in FIG. 1) in accordance with the present specification. FIG. 2A also shows a top view 204 of the tower unit 200, with a detail A of at least one corner where a wall of the tower unit 200 interfaces with a back panel 206. Persons skilled in the art can appreciate that the other corner of the tower unit 200 has a similar configuration as detailed herein. FIG. 2B illustrates an upright right-side view 208 of the tower unit 200 of FIG. 2A in accordance with an embodiment of the present specification. FIG. 2C illustrates a view of back panel 206, which is located at a rear side of tower unit 200 of FIG. 2A in accordance with an embodiment of the present specification. FIG. 2D illustrates a rear view of tower unit 200 of FIG. 2A, which is typically not visible due to the presence of the back panel 2 of FIG. 2C, in accordance with an embodiment of the present specification. A detail B illustrates a blown-out view of a top of the rear side of tower unit 200 as shown in FIG. 2D, in accordance with an embodiment of the present specification. A detail C illustrates a blown-out view of a bottom of the rear side of tower unit 200 as shown in FIG. 2D, in accordance with an embodiment of the present specification.

Referring simultaneously to FIGS. 2A to 2D, and the details shown therein, tower unit 200 has a height ranging from 8 inches to 59 inches. The actual height may vary based on whether tower unit 200 is for placing on a countertop or is configured for free-standing. FIGS. 2A to 2D represent an example of a freestanding, floor mounted size for the tower. Freestanding, floor-mounted towers are configured to fit within the general assembly illustrated in FIG. 1. A countertop tower assembly would use towers of shorter heights relative to those that are freestanding. Additionally, countertop towers would fit into a wooden envelope similar to the assembly shown in FIG. 1, albeit a smaller version of it. It should be understood by those of ordinary skill in the art that the tower assembly and its components, as described herein, can be re-sized proportionately to accommodate for different sizes, such as, but not limited to, the countertop version. In one embodiment, a free-standing tower unit 200 has a height of preferably 53.19 inches. In embodiments, tower unit 200 has a width ranging from 3 inches to 9 inches, and preferably 7.5 inches. In embodiments, tower unit 200 is made of stainless-steel. Tower unit 200 is folded at its center along its vertical axis, to form an obtuse angle between the two first sides or walls of the central fold, when viewed from the front. The two first walls are at an angle in a range of 90° to 180° relative to each other, when tower unit 200 is viewed from its rear side. The two first walls (also termed herein interchangeably as ‘first walls’), formed by the fold at the center, are further folded to form two parallel second walls (also termed herein interchangeably as ‘second walls’). The second walls are contiguous with their corresponding first walls. The second walls are even further folded inwards at a right angle, to the respective second walls, to form two third walls. Both third walls (continuing from the right side and the left side) are in the same plane, however, a space exists between the right and the left third walls of tower unit 200. Therefore, tower unit 200 in whole, when viewed from the top, is shaped in the form of a pentagon, where the rear side of the pentagon is only partially covered by the two third walls approaching each other in the same plane from opposing sides. The outer surface of the third walls, facing the rear side of tower unit 200, are covered by elongated magnetic strips 230. The magnetic strips 230 are used for attaching an inner surface of back panel 206 to the third walls, thereby enclosing the open pentagonal-shaped tower unit 200. Back panel 206, in some embodiments, has a height ranging from 7 to 58 inches, and preferably 52.07 inches for a free-standing tower unit 200, a width ranging from 2.84 to 8.84 inches, and preferably 7.34 inches, and a thickness ranging from 0.06 to 0.25 inch, and preferably 0.16 inch.

Referring again to FIG. 2D which shows the rear side of tower unit 200, a tubing 210 extends from a reservoir in the base box (not shown) proximal to bottom of tower unit 200, along the central fold of tower unit 200, between the two first walls. Tubing 210 extends towards the top of tower unit 200. In some embodiments tubing 210 has an outer diameter ranging from 0.25 to 0.75 inch, and preferably 0.5 inch, and an inner diameter ranging from ⅛ to ⅝ inch, and preferably 0.25 inch. Tubing 210 is hollow and is configured to carry fluids pumped from the reservoir in the base box upwards along the height of tower unit 200. In some embodiments a cable clip 212 with internal diameter ranging from 0.25 to 0.75 inch, and preferably 0.5 inch, is used to fix tubing 210 with a serrated nut 214, proximal the bottom of tower unit 200. In some embodiments, tubing 210 is also fixed to tower unit 200 at a location proximal to the top of tower unit 200, using a clip 216. At the top of tower unit 200, tubing 210 branches into at least two tubings 218 with an outer diameter ranging from 3/16 to 0.5 inch, and preferably 0.25 inch, and an inner diameter ranging from ⅛ to ⅜ inch, and preferably 0.125 inch. Branched tubings 218 extend from the central fold towards opposite sides (one to left and the other to right) and fold downwards along the rear surface of the first walls. Tubings 218 extend downwards till the top sides of topmost pod bezels 220 on the rear side of the first walls.

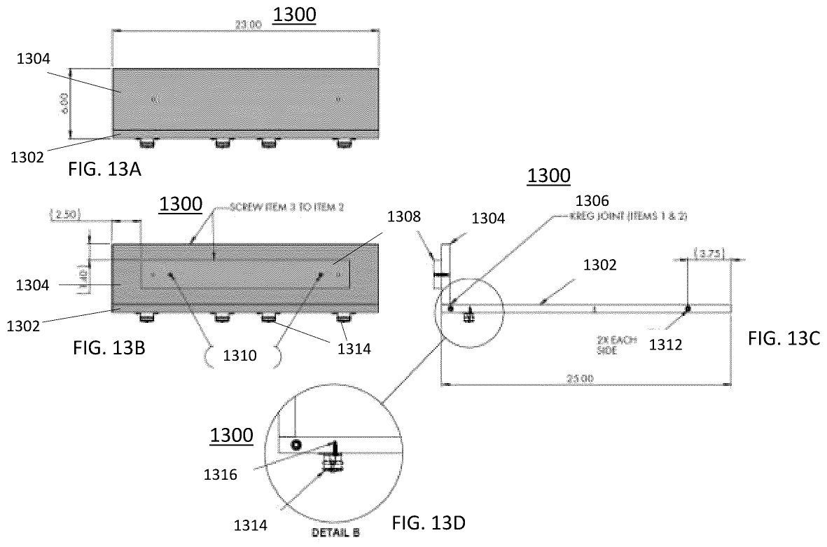

Each pod bezel 220 is bonded to tower unit 200 on its rear surface, using RTV silicone. Bezels 220 outline rectangular openings on the two first walls of tower unit 200, to support pods (not shown) that can be removably placed through the openings. Proximate to the top edges of the topmost pod bezels 220, tubings 218 are fixed to the first walls with cable clips 222 and serrated nuts 224. The clips 222 ensure that the tubings 218 remain in place even when the pressure of fluids flowing therein change. Further, Detail B illustrates a pair of strike plates 226 that are attached with the aid of screws 228 to the topmost corners of the rear side of tower unit 200, just above magnetic strips 230. An exemplary height of each strike plate 226 is in a range from 0.75 inches to 1.5 inches, and is preferably 1.13 inches, and they are also visible from the rear side as they are positioned above back panel 206 of tower unit 200. Strike plates 226 are used to attach the top of tower unit 200 to magnetic catches 1314 (FIG. 13D) positioned on the bottom side of the bottom surface of the top shelf (FIGS. 13A to 13D).

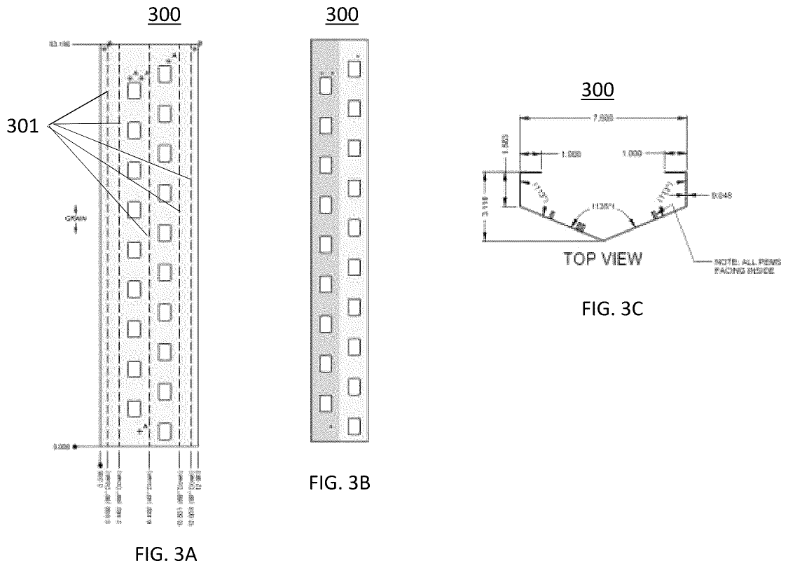

FIG. 3A illustrates an exemplary sheet of stainless steel 300 with dashed lines 301 that mark the locations of the folds created on the sheet to obtain the configuration of tower unit 200 (FIGS. 2A to 2D), in accordance with some embodiments of the present specification. FIG. 3B illustrates a front view of a tower unit obtained after folding the stainless-steel sheet 300 of FIG. 3A as per the illustrated specifications, in accordance with the embodiments. FIG. 3C illustrates a top view of the folded sheet 300 of FIG. 3A, in accordance with some embodiments of the present specification. Referring simultaneously to FIGS. 3A to 3C, an exemplary depth of the tower unit, as measured from the front-most point of the tower unit formed by the central fold between the two first walls, towards the rear-most plane formed by the two third walls, in a straight line, ranges from 2.5 inches to 4 inches, and is preferably 3.118 inches. An exemplary width from the left-most side of the tower to the right-most side in a horizontal plane is in a range of 1 to 9 inches and is preferably 7.5 inches. Each third side has a length in a range of 0.75 to 2 inches, and preferably 1 inch that extends from the left and right sides, towards the center of the tower unit. Also, each first wall has a length in a range from 0.75 inches to 2 inches, and of preferably 1.563 inches.

### Pod

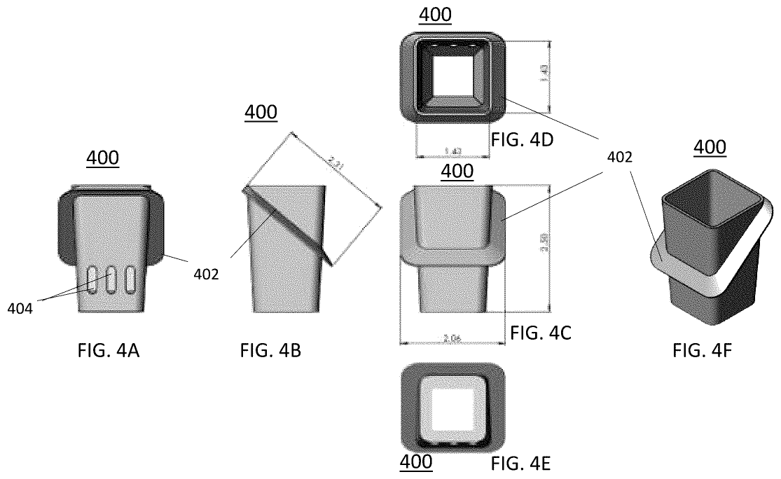

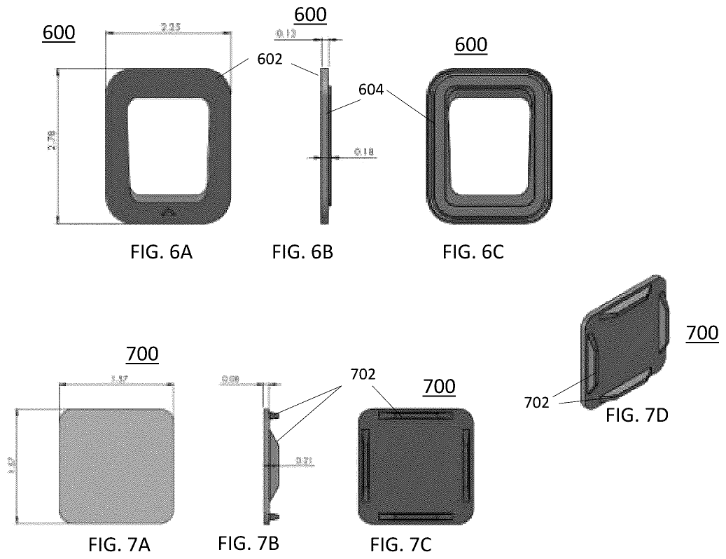

FIG. 4A illustrates a rear view of a pod 400 (pod 136 of FIG. 1) in accordance with an embodiment of the present specification. FIG. 4B illustrates a rear side of pod 400 in accordance with an embodiment of the present specification. FIG. 4C illustrates a front view of pod 400 in accordance with an embodiment of the present specification. FIG. 4D illustrates a top view of pod 400 in accordance with an embodiment of the present specification. FIG. 4E illustrates a bottom view of pod 400 in accordance with an embodiment of the present specification. FIG. 4F illustrates a perspective view of pod 400 in accordance with an embodiment of the present specification. FIGS. 4A to 4F show an embodiment of pod 400 with identical top and bottom dimensions of approximately 1.43 inches length and width. In embodiments, pod 400 may be rectangular or square, with its top and bottom lengths ranging from 1 inches to 2 inches, and widths ranging from 1 inch to 2 inches. The top side of pod 400 is open while the bottom is closed. The elongated sides between the top and the bottom are rectangular with a height of approximately 2.5 inches, and which together with the bottom surface, provide a container to receive at least one plant. One or more slots 404 are configured upon a rear wall of pod 400. After installation, each pod 400 is positioned such that slots 404 are facing upward. Slots 404 provide an opening that allows water/fluid stream coming from above through branches 218 of tubing 210 (see FIG. 2) to penetrate pod 400 and reach the plant within. In some embodiments, at least one wool cube is placed within each pod 400. The water/fluid coming in through slots 404 soaks into the wool cube that is holding the seeded plant. In some embodiments, and as illustrated in FIG. 4A, slots 404 have an elongated oval shape with a height ranging from 0.50 inches to 0.625 inches, preferably 0.56 inches; and a width ranging from 0.125 inches to 0.25 inches, preferably 0.18 inches. In some embodiments, more than one slot 404 are provided, which are centrally positioned along a width of rear wall of pod 400 and are equally spaced from each other. The illustrated embodiment shows three slots 404, but there can be a different number of slots in different embodiments. Each slot 404 slots facies upwards when pod 400 is installed to rest over a pod bezel. This allows the water stream coming from above to penetrate the pod and soak into the wool cube that is holding the seeded plant. A thin plate 402 is configured to skirt the periphery of pod 400 such that the plate 402 is tilted at an angle with the horizontal plane formed by the bottom surface of pod 400. In some embodiments, a bottom surface of plate 402 makes an angle of approximately 127° with a central longitudinal vertical axis of pod 400, and a top surface of plate 402 makes an angle of approximately 37° with a top horizontal place of pod 400. Plate 402 is integral to the body of pod 400 so that plate 402 is continuously attached to pod 400. The plate 402 provides a surface to rest pod 400 over a pod bezel (described subsequently in FIGS. 6A to 6C) in the tower unit in accordance with the present specification. In some embodiments, the plate 402 is slightly sloped downwards in a direction from the side proximal to the elongated sides of the pod, to the side that is distal. The plate 402 is configured to provide a seal with the pod bezel. In embodiments, pod 400 is 3D printed using PLA plastic with a 0.2 mm layer height.

### Reservoir Lid

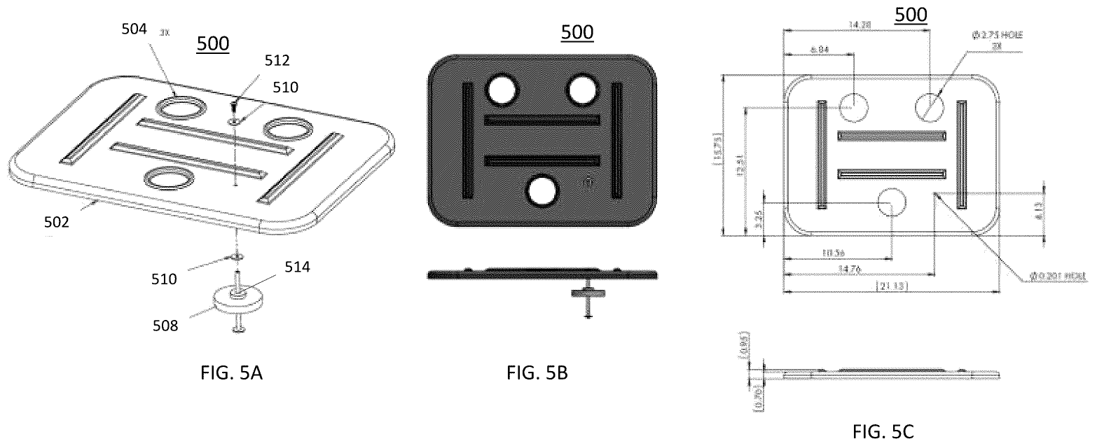

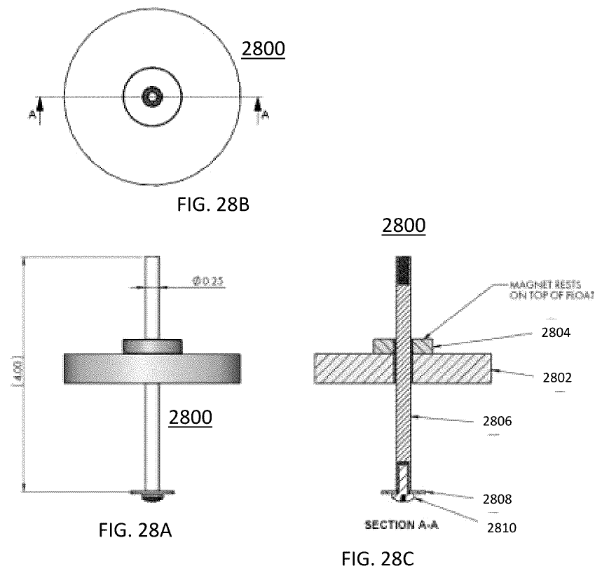

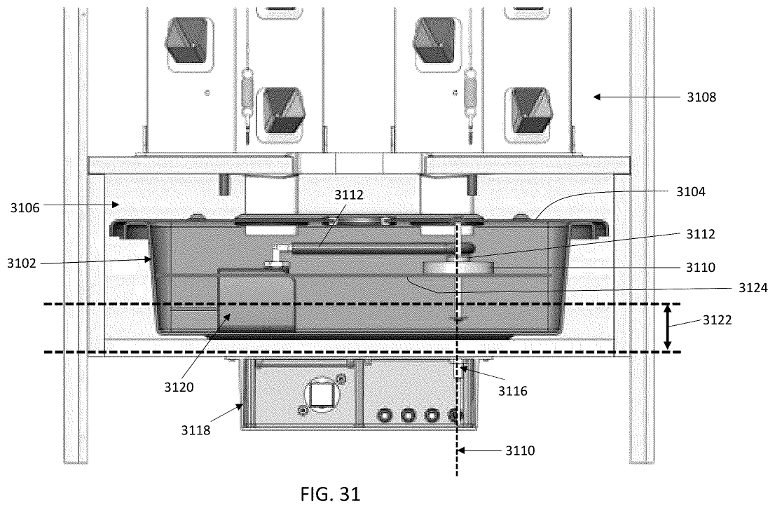

FIG. 5A illustrates a top perspective view of a lid assembly 500 (reservoir lid assembly 130 of FIG. 1) in accordance with some embodiments of the present specification. FIG. 5B illustrates a top view and a side elevation view of lid assembly 500. FIG. 5C illustrates exemplary dimensions of components of lid assembly 500 including a lid 502, and the positions and dimensions of grommets 504 in accordance with an embodiment of lid assembly 500. Referring simultaneously to FIGS. 5A, FIG. 5B, and FIG. 5C, lid assembly 500 is used to cover a reservoir that is positioned within the base box 106 of tower assembly 100 of FIG. 1. Lid 502 is rectangular with smooth rounded corners. A level sensor assembly comprising a float 508 and magnet 514 is in communication with surface of lid 502. Float 508 extends vertically downwards into a container that is configured to hold fluids including water. Washers 510 are used on either side (top and bottom surfaces) of lid 502 to attach level sensor assembly 508 to lid 502 using a screw 512. Magnet 514 rides on float 508, and float 508 rides on the water level. As the water level decreases, magnet 514 moves closer to the bottom of a reservoir within the base box (see reservoir tank 3102 of FIG. 31). When within a certain range, magnet 314 gets close to a magnetic field switch (reed switch) which causes a pump positioned within the reservoir to stop its operation. Operation of the level sensor assembly is explained further with reference to FIGS. 28A to 28C. In an embodiment, three circular grommets 504 with a diameter in a range of 1.5 to 4 inches, and preferably of 2.5 inches, are provided on the surface of lid 502. Two grommets 504 are positioned linearly along an axis parallel to and proximal to a rear edge of lid 502, and which provide openings to receive tower drains 132, 134 of FIG. 1 from two towers 108a and 108b of FIG. 1.

### Pod Bezel

FIG. 6A illustrates a front view of a pod bezel 600 in accordance with some embodiments of the present specification. FIG. 6B illustrates a side elevated view of pod bezel 600. FIG. 6C shows a rear side view of pod bezel 600. Referring simultaneously to FIGS. 6A to 6C, pod bezel 600 is rectangular in shape and has a height ranging from 2 to 4 inches, and preferably 2.78 inches, and a width ranging from 1.5 to 4 inches, and preferably 2.25 inches. The dimensions of pod bezel 600 compliment the dimensions of the rectangular openings in the towers 108a and 108b of FIG. 1, where each opening is fixed with pod bezel 600. Pod bezel 600 has two flat, plate-like surfaces—a front surface 602 that is visible in FIGS. 6A and 6B, and which is approximately 0.13 inch thick, and a rear surface 604 (shown in FIGS. 6B and 6C) that is visible from a front side of tower 108a/108b of FIG. 1, and which is approximately 0.05 inch thick. Therefore, a total thickness of pod bezel 600, in an embodiment, is approximately 0.18 inch. Front surface 602 has a wider surface as compared to rear surface 604. In embodiments, pod bezel 600 is 3D printed using PLA plastic of 0.2 mm layer height. Further, front surface 602 is visible on the front surface of first walls of tower 200 (see FIGS. 2A to 2D) whereas rear surface 604 is visible on the rear side of a first wall of tower 200. Each bezel 600 is bonded to the rear surface surrounding an opening in a first wall of tower 200. In some embodiments, material such as RTV silicone is used for the bonding. RTV silicone provides a flexible bond suitable for bonding two dissimilar materials. Additionally, RTV silicone provides a waterproof seal for the bond. The raised lip configured on rear surface 604 of bezel 600 indexes to a cutout configured correspondingly in metal tower 200 thus aligning around the opening. In some embodiments, front surface 602 is embossed with an arrow shape proximal to a base of bezel 600, to indicate the side that should be pointing upward during the bonding/installation of bezel 600. The arrow, or any other mark, may be used to prevent accidental installation of bezel 600 in an incorrect position.

### Pod Lid

FIG. 7A illustrates a view of a top surface of a pod lid 700 that may be used to cover pod 400 of FIGS. 4A to 4F in accordance with some embodiments of the present specification. FIG. 7B illustrates a side view of lid 700. FIG. 7C illustrates a view of the bottom surface of the lid 700. FIG. 7D illustrates a bottom side perspective view of lid 700. In some embodiments, pod lid 700 is 3D printed from PLA plastic of 0.2 mm layer height. Lid 700 is square with each side measuring approximately 1.57 inches. Corners of lid 700 are rounded and the dimensions are configured to complement the top opening of pod 400 of FIGS. 4A to 4F. Each edge on the bottom surface of lid 700 has a protruding platform 702. Lid 700 is approximately 0.08 inch thick, and the platforms 702 are each approximately 0.13 inch thick. The platforms 702, located at a distance in a range of 0.03 to 0.13 inch, and preferably 0.05 inch, inwards from each edge of the lid. In some embodiments, platforms 702 are angled slightly to provide a tapered fit when they are inserted into the pod. Configuration of platforms 702 allows them to fit easily into the pod opening initially, but provide a little friction as lid 700 is pushed all the way into the pod. Pod lid 700 can be used to cover empty (unplanted) pods 400 placed in the towers 108a and 108b of FIG. 1.

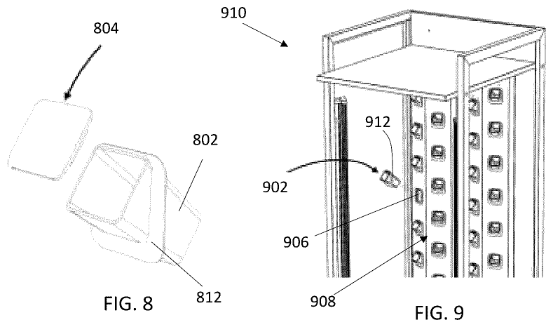

Pods (136 of FIGS. 1 and 400 of FIGS. 4A to 4F) are inserted into the tower unit (108a/108b of FIG. 1) through the front face of the tower unit, so that each pod is placed through a rectangular opening lined with pod bezels (600 of FIGS. 6A to 6C) at the rear face of the tower unit. Each opening of the tower units is fitted with a pod using the bezel. FIG. 8 illustrates an orientation of a pod positioned for insertion into an opening of a tower and FIG. 9 illustrates the orientation of the pod positioned relative to the tower orientation while inserting into a tower opening, in accordance with some embodiments of the present specification. Referring to FIGS. 8 and 9 simultaneously, FIG. 8 illustrates an orientation of a pod 802 with a matching pod lid 804 that is adapted while inserting pod 802, 902 into an opening 906 of a tower unit 908 within a tower assembly 910 shown in FIG. 9. FIG. 9 shows the orientation of pod 902 as seen relative to tower unit 908 orientation while inserting into opening 906. The top open surface of pod 802, 902 is at an angle relative to the vertical surface of opening 906 of tower unit 908. A user has to apply pressure to install pod 802, 902 by pushing pod 802, 902 through its corresponding opening 906, till a plate 812, 912 that skirts pod's 802, 902 periphery is aligned around the vertical surface of tower unit 908 that surrounds opening 906. Plate 812, 912 skirting pod 802, 902 provides a seal with tower unit 908 when appropriate pressure is applied during installation of pod 802, 902. When all the pods 802, 902 are installed through the available openings 906, plants may be added inside each pod 802, 902. In some embodiments, pre-designed grow blocks are inserted into pods 802, 902. The grow blocks are configured according to the design and dimensions of pods 802, 902 for user's convenience. If some pods are empty, pod lids 804, 904 are used to cover them, and thereby prevent any water from splashing out of the pods 802, 902.

### Side Structure Assembly

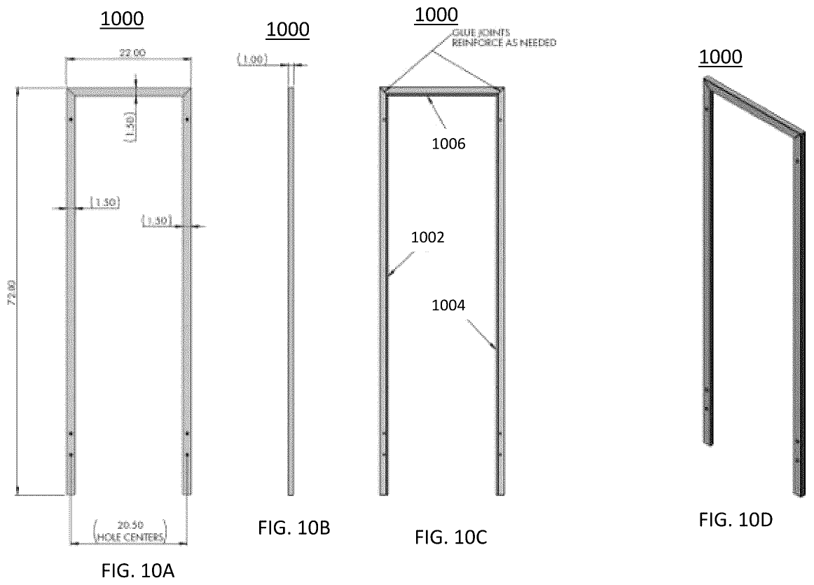

FIG. 10A illustrates a first (outer) side view of a side structure 1000 (left and right-side structures 1a and 1b of FIG. 1) in accordance with some embodiments of the present specification. FIG. 10B illustrates a front view of side structure 1000 in accordance with some embodiments of the present specification. FIG. 10C illustrates a second (inner) side view (facing the towers) of side structure 1000 in accordance with some embodiments of the present specification. FIG. 10D illustrates a side perspective view of side structure 1000 in accordance with some embodiments of the present specification. Referring simultaneously to FIGS. 10A to 10D, a total height of side structure 1000 is in a range of 16 to 78 inches, and preferably 72 inches. Structure 1000 is made using metal frames that may be welded together. In some embodiments, CNC frames made from sheet stock panels of wood or plastic, are used. In an embodiment, traditional solid wood pieces are glued and held together using traditional wood joinery techniques to make structure 1000. Structure 1000 is formed by three sides—two parallel vertical portions—front vertical portion 1002 and rear vertical portion 1004 of approximately 1.5 inches width and approximately 1 inch depth; wherein the two portions are joined together at their tops by a horizontal portion 1006 of approximately 22 inches length and 1.5 inches width. In some embodiments, horizontal portion 1006 is attached to vertical portions 1002, 1004 using glue joints, welds, mechanical joints such as those using brackets, screws, or any other type of joint, that may be reinforced as needed. In the case of wooden material used for structure 1000, woodworking techniques like mortise and tenon, Kreg Joinery or dowel assemblies, may be used for the joints. In some embodiments, structure 1000 is made from a single sheet so that there are no joints. At least one hole proximate a bottom side of each vertical portion 1002, 1006 is provided to pass a screw to attach a base box (base box 106 of FIG. 1). Additional two holes are included along the vertical portions 1002, 1004 to accommodate attachments for a light. A horizontal distance between centers of two corresponding holes on the two vertical portions 1002, 1004 is in a range of 6 to 30 inches, and preferably 20.5 inches.

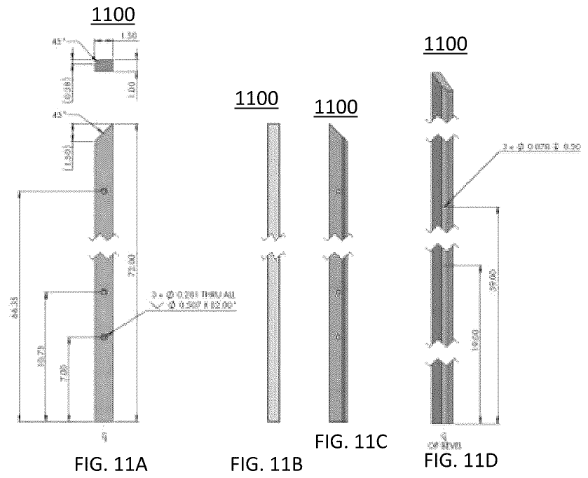

FIG. 11A illustrates an outer side view of a front vertical portion 1100 (1002 of FIG. 10C) in accordance with some embodiments of the present specification. FIG. 11B illustrates a front view of vertical portion 1100 in accordance with some embodiments of the present specification. FIG. 11C illustrates an inner side view of front vertical portion 1100 in accordance with some embodiments of the present specification. FIG. 11D illustrates a front and side perspective view of front vertical portion 1100 in accordance with some embodiments of the present specification. Each vertical portion 1100 may also be referred to herein as the vertical rail 1100. The dimensions and angles marked in the figure similarly apply to rear vertical portion (1004 of FIG. 10C).

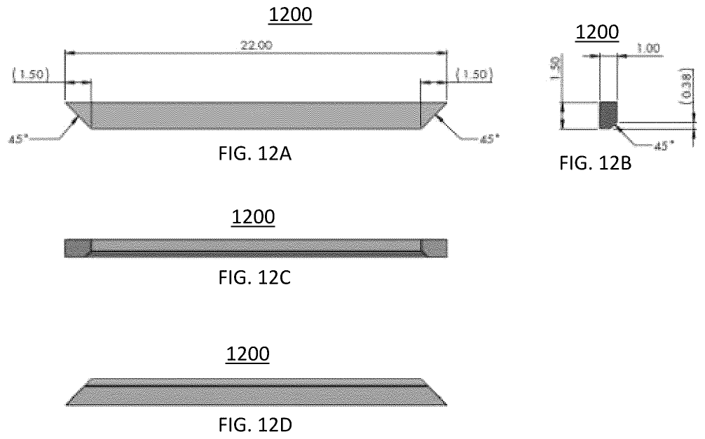

FIG. 12A illustrates a front view of a horizontal portion 1200 (1006 of FIG. 10C) in accordance with some embodiments of the present specification. FIG. 12B illustrates a side view of horizontal portion 1200 in accordance with some embodiments of the present specification. FIG. 12C illustrates a bottom view of horizontal portion 1200 in accordance with some embodiments of the present specification. FIG. 12D illustrates a rear side view of horizontal portion 1200 shown in FIG. 12A in accordance with some embodiments of the present specification. Horizontal portion 1200 may also be referred to herein as the horizontal rail 1200.

### Top Shelf Assembly

FIGS. 13A to 13D illustrate various views of a top shelf assembly 1300 (top shelf assembly 104 of FIG. 1). FIG. 13A illustrates a front side view of top shelf assembly 1300 in accordance with some embodiments of the present specification. FIG. 13B illustrates a rear side view of top shelf assembly 1300 in accordance with some embodiments of the present specification. FIG. 13C illustrates a side view of top shelf assembly 1300 in accordance with some embodiments of the present specification. FIG. 13D illustrates a blown-out view of a magnetic catch assembly on a bottom surface of top shelf assembly 1300 in accordance with some embodiments of the present specification. Referring simultaneously to FIGS. 13A to 13D, height of assembly 1300 can be in a range of 2 to 10 inches and is of 6 inches in an embodiment, width of assembly 1300 is in a range of 10 to 30 inches and is of 23 inches in the embodiment, and depth ranges from 10 to 30 inches and is approximately 25 inches in the same embodiment. A horizontal shelf panel 1302 is attached perpendicularly to a vertical shelf panel 1304 at a back side of the former. Panels 1302 and 1304 are made using plywood. Wood, plastic sheets, sheet metal, or any other material. Both panels 1302 and 1304 are rectangular in shape. The attachment between panels 1302 and 1304 is achieved with a Kreg joint 1306 in some embodiments. A wall spacer 1308 is centrally positioned on the rear surface of vertical panel 1304, which is the side of panel 1304 that faces the wall during installment of the tower assembly (see FIGS. 9A, 9B). Wall spacer 1308 is screwed with at least a pair of wood screws 1310 to attach to vertical panel 1304. In some embodiments, the wall spacer 1308 is centrally positioned behind vertical panel 1304 so that a width of approximately 2.5 inches is spared horizontally on either side of wall spacer 1308, and a height of approximately 1.4 inches is spared vertically on either side of wall spacer 1308. In some embodiments, a pair of brass inserts 1312 is threaded internally to horizontal panel 1302 from opposite sides of its width, at a depth of approximately 3.75 inches from its front edge. In embodiments, multiple magnetic catches 1314 are attached with screws 1316 to a bottom surface of horizontal panel 1302. In some embodiments, four magnetic catches 1314 are attached along a row parallel and proximal to a rear edge of horizontal panel 1302. A pair of catches 1314 are configured to provide a connection mechanism to align and attach walls of a tower unit to the top shelf assembly 1300. Catches 1314 attach to strike plates 226 (detail B of FIG. 2D) that are attached to the topmost corners of the rear side of tower unit 200 of FIGS. 2A to 2D. Each pair of catches 1314 are spaced to corresponding distance between third side walls of each tower unit.

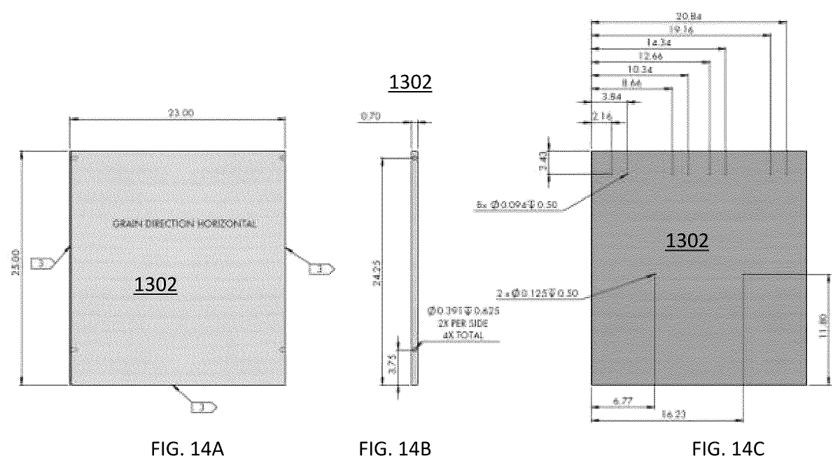

FIG. 14A illustrates a top view of horizontal panel 1302 of FIG. 13A to 13C in accordance with some embodiments of the present specification. FIG. 14B illustrates a side view of horizontal panel 1302. FIG. 14C illustrates a bottom view of horizontal panel 1302. FIGS. 14A to 14C also illustrate exemplary measurements and dimensions of the various components of the horizontal panel 1302. In some embodiments, horizontal panel 1302 is made using plywood, such as birch plywood with a thickness of 0.6 to 1 inch, and preferably 0.7 inch. The edges of horizontal panel 1302 may be covered with edge band faces using matching veneer.

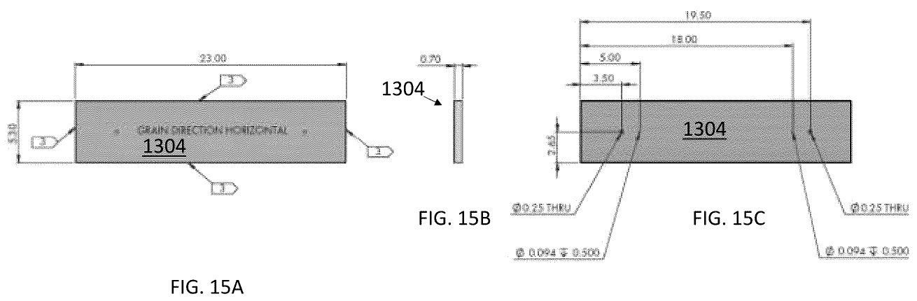

FIG. 15A illustrates a front view of vertical panel 1304 in accordance with some embodiments of the present specification. FIG. 15B illustrates a side view of vertical panel 1304. FIG. 15C illustrates a rear view of vertical panel 1304. The material specification of vertical panel 1304 can be the same as those for the horizontal panel. FIGS. 15A to 15C also illustrate exemplary measurements and dimensions of the various components of vertical panel 1304.

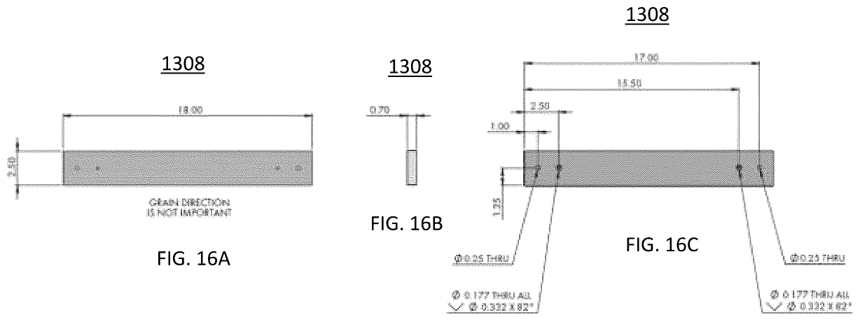

FIG. 16A illustrates a front view of wall spacer 1308 of FIGS. 13A to 13C in accordance with some embodiments of the present specification. FIG. 16B illustrates a side view of wall spacer 1308. FIG. 16C illustrates a rear view of wall spacer 1308. The material specification of the wall spacer can be the same as those for horizontal panel 1302. FIGS. 16A to 16C also illustrate exemplary measurements and dimensions of the various components of wall spacer 1308.

### Base Box Assembly

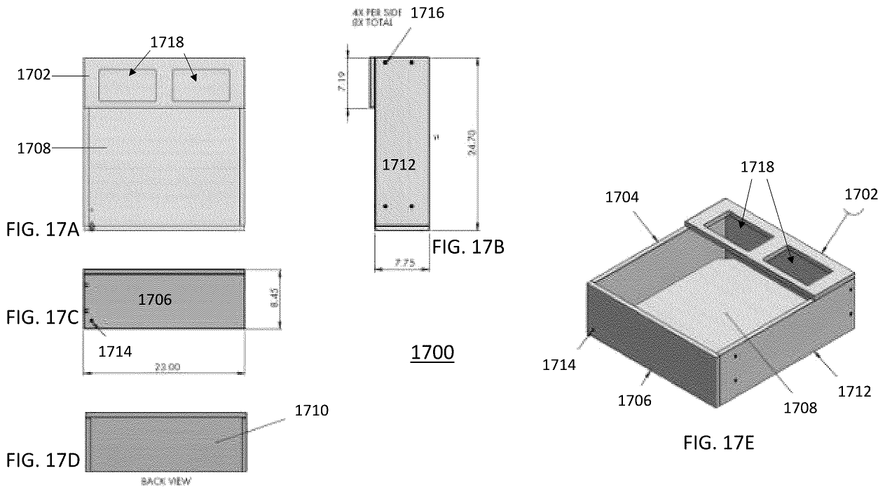

FIGS. 17A to 17E illustrate various views of rectangular base box 1700 (base box 106 of FIG. 1). FIG. 17A illustrates a top side view of base box 1700 in accordance with some embodiments of the present specification. FIG. 17B illustrates a right-side view of base box 1700. FIG. 17C illustrates a front side view of base box 1700. FIG. 17D illustrates a back side view of base box 1700. FIG. 17E illustrates a perspective view of base box 1700. FIG. 17E shows an overall assembly of a top panel 1702, a left side panel 1704, a front panel 1706, a bottom panel 1708, a back panel 1710, a right-side panel 1712, and an indicator light 1714 embedded on front panel 1706. The various panels are permanently assembled with Kreg joints. Referring simultaneously to FIGS. 17A to 17E, top panel 1702 provides at least two rectangular hollows 1718 through its surface, where each hollow 1718 is configured to accommodate drain of a tower (tower drains 132, 17 of FIG. 1). In some embodiments, the measurements and dimensions of the various components of base box 1700 are as follows: top panel 1702 has a depth ranging from 4 to 10 inches, and preferably of approximately 7.19 inches extending from its front edge to its back edge; total depth of base box 1700 is in a range from 7 to 30 inches and preferably approximately 24.7 inches such that top panel 1702 is positioned along a rear edge of the top of base box 1700. A total height of base box 1700 is in a range from 2 to 10 inches, and preferably approximately 8.45 inches, and a total width is in a range of 4 to 30 inches and approximately 23 inches in an embodiment. In one embodiment, indicator light 1714 is positioned proximal to a bottom left corner on front panel 1706 of base box 1700. In an embodiment, side panel 1712 has a height ranging from 2 to 10 inches, and preferably of 7.75 inches, and a length extending from the front to the rear side of base box 1700 that ranges from 5 to 30 inches and is preferably of approximately 24 inches. Side panels 1712, 1704, like all other panels of base box 1700, are preferably made using a 0.7-0.8 inch thick birch plywood with edge band faces that use matching veneer.

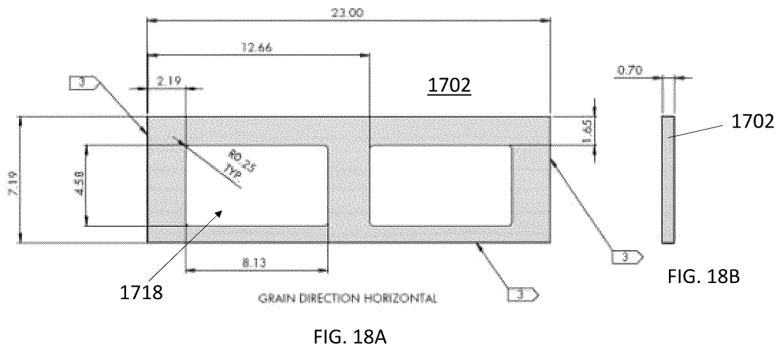

FIG. 18A illustrates a top view of top panel 1702 of FIGS. 17A to 17E in accordance with some embodiments of the present specification. FIG. 18B illustrates a view from the right edge of top panel 1702. In some embodiments, top panel 1702 is made using plywood, such as birch plywood with a thickness of 0.6 to 1 inch, and preferably 0.7 inch. The outer edges of top panel 1702 may be covered with edge band faces using matching veneer. FIGS. 18A and 18B also illustrate exemplary measurements and dimensions of top panel 1702. Top panel 1702 has two rectangular cutouts 1718 that are equally spaced out in the surface of panel 1702. Panel 1702 has a width ranging from 22.875 inches to 23 inches, and preferably of 23 inches, and a depth ranging from 7.125 inches to 7.25 inches and preferably of 7.19 inches, wherein each rectangular cutout 1718 has a width ranging from 8.0625 inches to 8.1875 inches and preferably of 8.13 inches and a depth ranging from 4.50 inches to 4.625 inches and preferably of 4.58 inches.

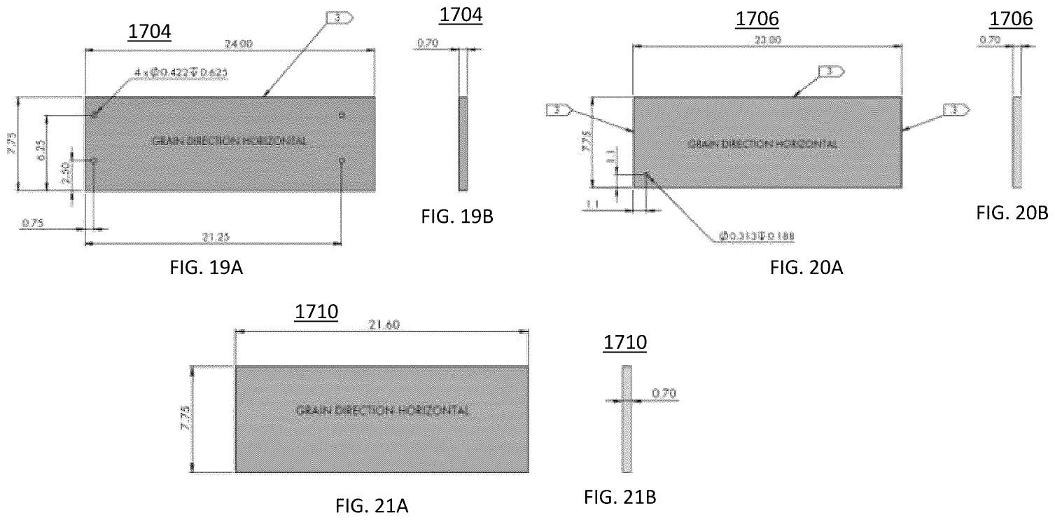

FIG. 19A illustrates a front view of rectangular left side panel 1704 of FIGS. 17A to 17C in accordance with some embodiments of the present specification. FIG. 19B illustrates a view of a right-side edge of left side panel 1704. While the figures describe the left side panel 1704, similar description is applicable to right side panel 1712, and is not repeated herein for brevity. In some embodiments, panel 1704 is made using plywood, such as birch plywood with a thickness of 0.6 to 1 inch, and preferably 0.7 inch. The outer edges of panel 1704 may be covered with edge band faces using matching veneer. FIGS. 19A and 19B also illustrate exemplary measurements and dimensions of the left (and right) side panel 1704.

FIG. 20A illustrates a front view of rectangular front panel 1706 of FIGS. 17A to 17E in accordance with some embodiments of the present specification. FIG. 20B illustrates a view of a right-side edge of front panel 1706. In some embodiments, panel 1706 is made using plywood, such as birch plywood with a thickness of 0.6 to 1 inch, and preferably 0.7 inch. The outer edges of panel 1706 may be covered with edge band faces using matching veneer. FIGS. 20A and 20B also illustrate exemplary measurements and dimensions of front panel 1706.

FIG. 21A illustrates a front view of rectangular back panel 1710 of FIGS. 17A to 17E in accordance with some embodiments of the present specification. FIG. 21B illustrates a view from the right side of rectangular back panel 1710. In some embodiments, panel 1710 is made using plywood, such as birch plywood with a thickness of 0.6 to 1 inch, and preferably 0.7 inch. The outer edges of panel 1710 may be covered with edge band faces using matching veneer. FIGS. 21A and 21B also illustrate exemplary measurements and dimensions of back panel 1710.

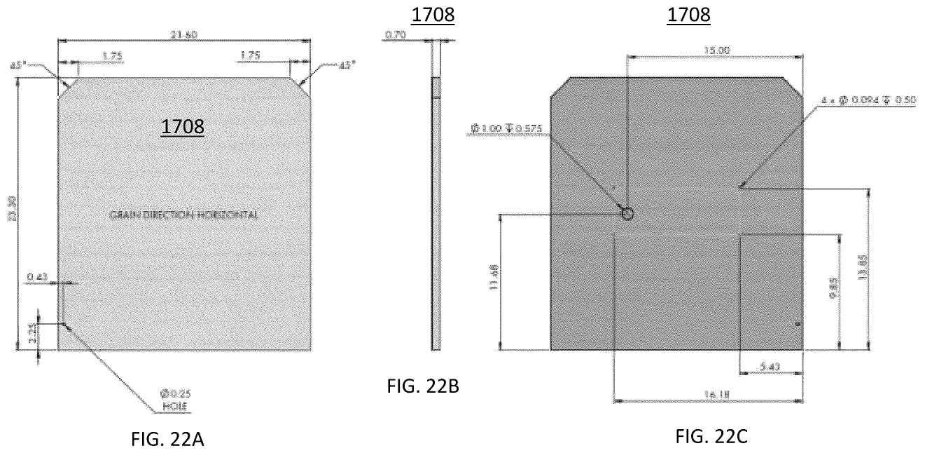

FIG. 22A illustrates a top view of bottom panel 1708 of FIGS. 17A to 17E in accordance with some embodiments of the present specification. FIG. 22B illustrates a view from the right side of bottom panel 1708. FIG. 22C illustrates a bottom view of bottom panel 1708. In some embodiments, panel 1708 is made using plywood, such as birch plywood with a thickness of 0.6 to 1 inch, and preferably 0.7 inch. The outer edges of panel 1708 may be covered with edge band faces using matching veneer. FIGS. 22A to 22C also illustrate exemplary measurements and dimensions of the bottom panel.

### Tower Drain

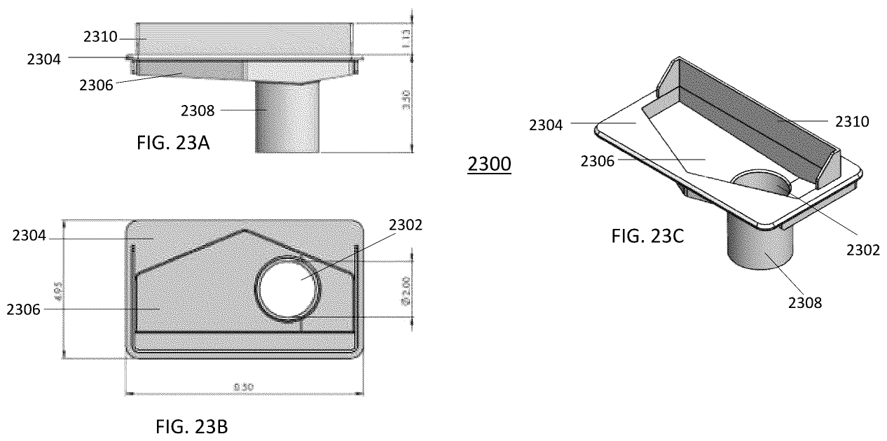

FIG. 23A illustrates a side view of a first tower drain 2300 (tower drain 132 of FIG. 1) which can be installed on the left-hand side of tower assembly 100 of FIG. 1, in accordance with some embodiments of the present specification. FIG. 23B illustrates a top view of tower drain 2300. FIG. 23C illustrates a perspective view of tower drain 2300. In some embodiments, tower drain 2300 is 3D printed using PETG or PLA plastic, with a 0.3 millimeters (mm) layer height. Persons skilled in the art can appreciate that while the figures illustrate the tower drain part for installation on left side of the tower assembly, an identical description is applicable to its counterpart tower drain part for installation on the right side of the tower assembly. In some embodiments, however, a circular hole 2302 as shown in FIGS. 23A to 23C are on the right side for the tower drain on the right side. The specifications for the right-side counterpart are not repeated herein for brevity.

Referring simultaneously to FIGS. 23A to 23C, tower drain 2300 comprises a top flat rectangular surface 2304 portion with a pentagonal depression 2306 centrally positioned on flat surface 2304. Pentagonal depression 2306 is configured to receive base of a tower unit (tower unit 108a of FIG. 1) and has a surface sloping downwards towards circular hole 2302 that is attached to a cylindrical pipe 2308 that extends from the bottom surface of tower drain 2300 into base box 106 of FIG. 1. In some embodiments, a vertical wall 2310 is configured above the top surface of the flat rectangular portion 2304, along the rear top edge of the pentagonal depression 2306 and extends partially on either side of the pentagonal depression 2306. In some embodiments, the wall 2310 stretches for a height in a range of 0 to 2 inches, and preferably up to 1.13 inches, which provides support to second and third walls of the tower unit that tower drain 2300 is configured to receive. Sloping sides of pentagonal depression 2306 are also configured to receive the first, second, and third walls of the tower unit, where the walls of the tower unit and therefore the corresponding walls of pentagonal depression 2306 are oriented at specified angles to each other (see specification corresponding to FIGS. 2A to 2D and 3A to 3C). The circular hole 2302 and the cylindrical pipe 2308 have a diameter in a range of 1.6875 inches to 2.0625 inches, and preferably of approximately 2 inches, to enable drainage from the received tower unit. A height of tower drain 2300 from the top flat surface of rectangular portion 2304 to the bottom edge of pipe 2308 is in a range of 0 to 5 inches, and is preferably approximately 3.5 inches. The length and breadth of the rectangular top flat surface 2304 is approximately and respectively, 4.95 inches and 8.5 inches, in an embodiment. In various embodiments, the length of portion 2304 may range from 3 to 10 inches and the breadth may range from 2 to 8 inches. A bottom end of a tower unit is positioned sit on tower drain 2300 so that fluids drained from the tower unit pass through drain 2300, where pipe 2308 of drain 2300 passes through rectangular openings 1718 of FIGS. 17A to 17E, designed in top panel 1702 of a base box 1700. The drained fluids are therefore carried back into a reservoir within the base box.

### Lid Assembly

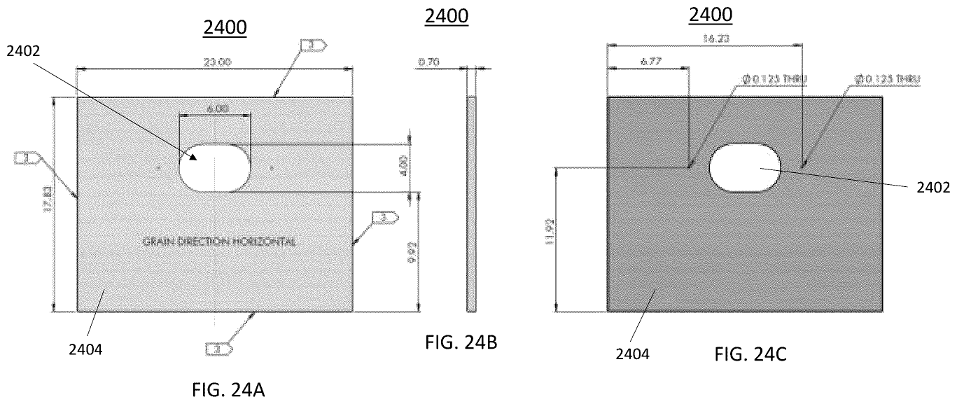

FIG. 24A illustrates a top surface view of a lid panel 2400 (lid 114 of FIG. 1) that is positioned on top of base box (base box 106 of FIG. 1, base box 1700 of FIGS. 17A to 17E) in the same plane as top panel 1702 of FIGS. 17A to 17E, in accordance with some embodiments of the present specification. FIG. 24B illustrates a side view of lid panel 2400. FIG. 24C illustrates a bottom surface view of lid panel 2400. Referring simultaneously to FIG. 24A to 24C, an opening 2402 is provided on a surface 2404 to enable passage of water and nutrients (fluids) through lid panel 2400, into a reservoir within the base box. In an embodiment, lid panel 2400 is rectangular with a length in a range of 2 to 30 inches, and preferably of approximately 17.83 inches; and a width in a range of 5 to 30 inches and preferably of approximately 23 inches. In the embodiment, opening 2402 is oval-shaped with a length of 4 inches, and a width of approximately 6 inches, and is positioned so that its frontal edge is located at approximately 9.92 inches from a front edge of lid panel 2400; and its center is located at approximately 11.5 inches from wither of the side edges of lid panel 2400. In some embodiments, lid panel 2400 is made using plywood, such as birch plywood with a thickness of 0.6 to 1 inch, and preferably 0.7 inch. The edges of lid panel 2400 may be covered with edge band faces using matching veneer.

### Fill Port

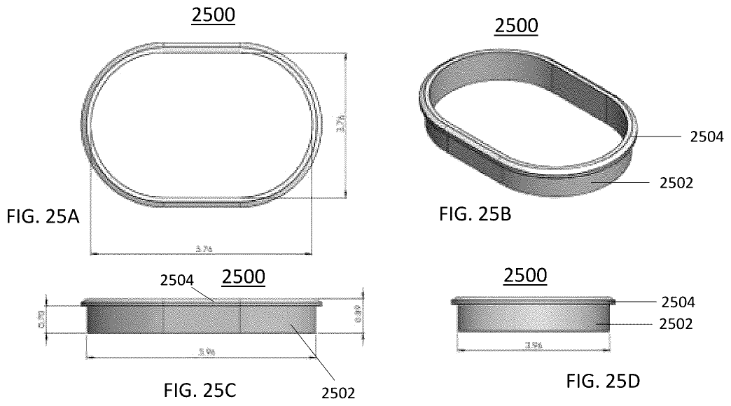

FIG. 25A illustrates a top view of an oval-shaped fill port 2500 to fit and outline the opening 2402 in lid panel 2400 of FIGS. 24A to 24C, in accordance with some embodiments of the present specification. FIG. 25B illustrates a perspective view of fill port 2500. FIG. 25C illustrates a long-side view of fill port 2500. FIG. 25D illustrates a short-side view of fill port 2500. Referring simultaneously to FIGS. 25A-25D, fill port 2500 comprises an oval-shaped vertical wall 2502 to compliment the oval-shaped opening in lid panel embodiment shown in FIGS. 24A-24C. An inner length of fill port 2500 is approximately 3.76 inches while an outer length is approximately 3.96 inches, and an inner width is approximately 5.76 inches while the outer width is approximately 5.96 inches. An exemplary height of wall 2502 of fill port 2500 is approximately 0.7 inch. A roof 2504 attached on a top edge of wall 2502 increases the height to approximately 0.89 inch. In embodiments, fill port 2500 is 3D printed using PETG or PLA plastic with a 0.3 mm layer height.

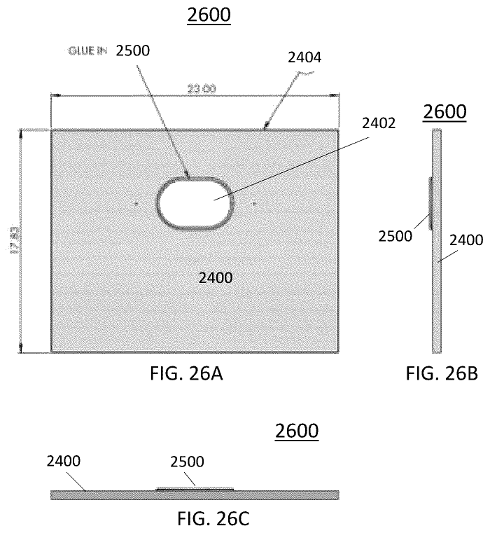

FIG. 26A illustrates fill port 2500 of FIGS. 25A-25D assembled to form a flow port assembly 2600, on lid panel 2400 of FIGS. 24A-24C in accordance with some embodiments of the present specification. FIG. 26B illustrates a right-side view of flow port assembly 2600. FIG. 26C illustrates a front side view of flow port assembly 2600. In some embodiments, fill port 2500 is glued onto the sides of opening 2402 on the lid panel 2400, such that roof 2504 outlining fill port 2500 rests above top surface 2404 of lid panel 2400, surrounding opening 2402.

### Electrical Box

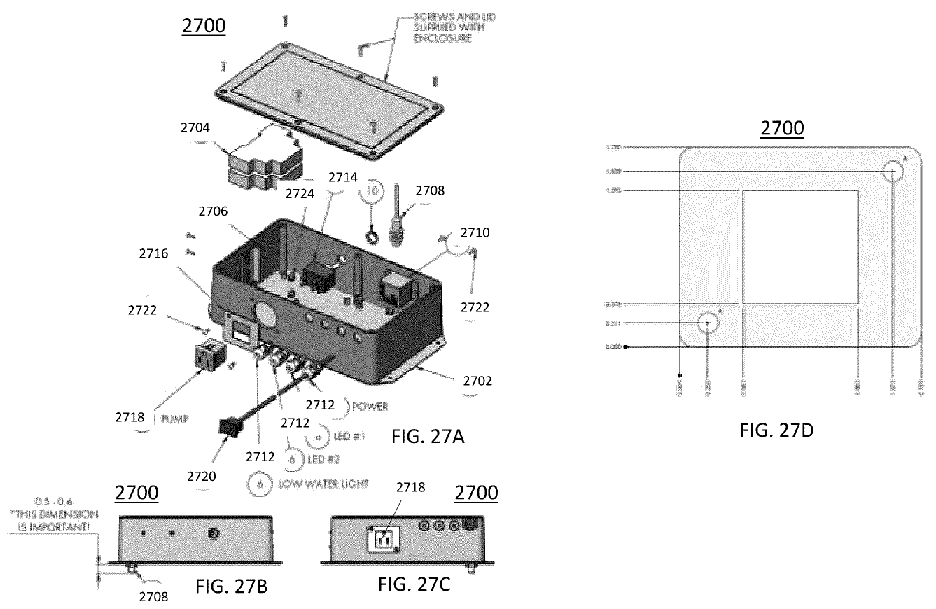

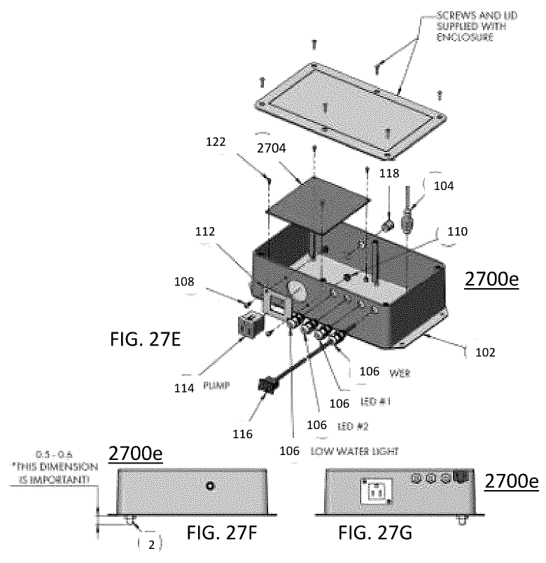

FIG. 27A illustrates a blown-out view of the components of an electrical box 2700 (electrical box 110 of FIG. 1) in accordance with some embodiments of the present specification. FIG. 27B illustrates a first side view of electrical box 2700 in its assembled state, in accordance with some embodiments of the present specification. FIG. 27C illustrates a second side (opposite to the first side) view of electrical box 2700 in its assembled state, in accordance with some embodiments of the present specification. Electrical box 2700 is preferably made from plastic and comprises a rectangular enclosure 2702 with a removable lid. The lid is fixed to the top side of the housing formed by box 2700 using multiple screws. The components enclosed by the plastic enclosure 2702 include: a timer 2704; a steel rail 2706; a reed switch 2708; a relay 2710; at least four cord grips 2712; a switch 2714; a receptacle plate 2716 fixed on an outer surface of the enclosure 2702; an electrical receptacle 2718 fitted through the receptacle plate 2716; and a plug 2720 connected to one of the cord grips 2712 for power. At least two of the cord grips 2712 may be used to display LED lights, and one cord grip 2712 may be used to display a low-water light. All the cord grips 2712 are fitted on one of the walls of the enclosure 2702 through matching openings. The low water light can be used as a visual indication to notify low water levels within the reservoir in the base box. Receptacle 2718 may be used to connect a pump (described subsequently). Additionally, the components are joined together using multiple screws 2722 and locknuts 2724.

In an embodiment, switch 2714 is a toggle switch. In another embodiment, switch 2714 is a push button switch that is controlled by a circuit board. FIG. 27D illustrates an exemplary structure of receptacle plate 2716 in accordance with the present specification. Plate 2716 is configured to encompass electrical receptacle 2718 which can hold a 115V female plug.

FIG. 27E illustrates a blown-out view of the components of an electrical box 2700e (electrical box 110 of FIG. 1) in accordance with some alternate embodiments of the present specification. FIG. 27F illustrates a first side view of electrical box 2700e in its assembled state, in accordance with some embodiments of the present specification. FIG. 27G illustrates a second side (opposite to the first side) view of electrical box 2700e in its assembled state, in accordance with some embodiments of the present specification. Embodiment of components of FIGS. 27E to 27G are similar to those of FIGS. 27A to 27D, except that timer 2702 illustrated in FIG. 27A is substituted with a printed circuit board (PCB) 2704e comprising the timing circuit and its associated electronics.

FIG. 28A illustrates an elevation view of an exemplary level sensor assembly 2800 (connected to reed switch 2708 of FIGS. 27A to 27C) used in accordance with some embodiments of the present specification. Level sensor assembly 2800 is additionally illustrated and described in context of FIG. 5A as level sensor assembly 508. FIG. 28B illustrates a top view of assembly 2800. FIG. 28C illustrates a section view of assembly 2800. Assembly 2800, when connected to reed switch 2708, forms a part of an electromechanical switching device that operates based on an applied magnetic field. In embodiments, assembly 2800 is connected to water sensor reed switch 2708 which is positioned partially within enclosure 2702 of FIGS. 27A and 27B, and partially outside, through the bottom surface of enclosure 2702. In an embodiment, the length of assembly 2800 that extends out from the bottom surface of the enclosure is in a range of 0.5 to 0.6 inch. The switch comprises: a circular float 2802; a circular magnet 2804 (preferably epoxy-coated) that rests above and at the center of float 2802; a vertical threaded nylon standoff 2806 (of approximately 4 inches length and 0.25 inch diameter) passes through the centers of the float 2802 and magnet 2804; and a washer 2808 is attached to the bottom side of standoff 2806 to provide a seal with a screw 2810 fitted into the threaded cylinder inside standoff 2806. In one embodiment, float 2802 is made from a 0.5 inch thick closed cell polyethylene foam having a 2 lb density. Float 2802 has a diameter of 3 inches with a central circular opening of approximately 0.313 inch diameter to enable passage of standoff 2806. Float 2802 floats above the water level inside a reservoir containing fluid or water, inside where the pump assembly is also positioned. Details of assembly 2800 and its positioning relative to the reed switch, the pump and other components in the tower unit are described in context of FIG. 31.

### Vine Wire

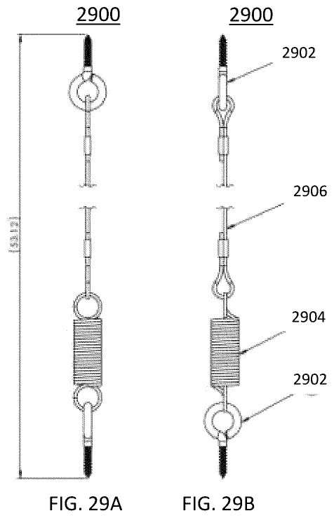

FIG. 29A illustrates an elongate first view of a vine wire 2900 (vine wire 116 of FIG. 1) in accordance with some embodiments of the present specification. FIG. 29B illustrates another elongated second view, which is the first view of vine wire 2900 rotated by 90°, in accordance with embodiments of the present specification. Referring simultaneously to FIGS. 29A and 29B, a vertical length of the vine wire is in a range of 8 to 60 inches, and preferably approximately 53.12 inches. Vine wire 2900 extends from the bottom of a tower unit (such as tower units 108a, 108b of FIG. 1) to its top, and is positioned proximate at least one vertical column of pod bezels (pod bezel 600 of FIGS. 6A to 6C), or both. Vine wire 2900 provides a support to grow and propagate plants placed within pods (pods 136 of FIG. 1) which are positioned on the pod bezels of the tower unit. The top and bottom sides of vine wire 2900 each include a threaded screw attached to an eyelet 2902. Eyelet 2902 on the bottom side is further attached to a first side of a spring 2904. Second side of spring 2904 and eyelet 2902 of the top side of vine wire 2900 are attached to a steel wire 2906. Steel wire 2906 is hooked to top eyelet 2902 and spring 2904 on its top and bottom ends respectively.

### Pump Assembly

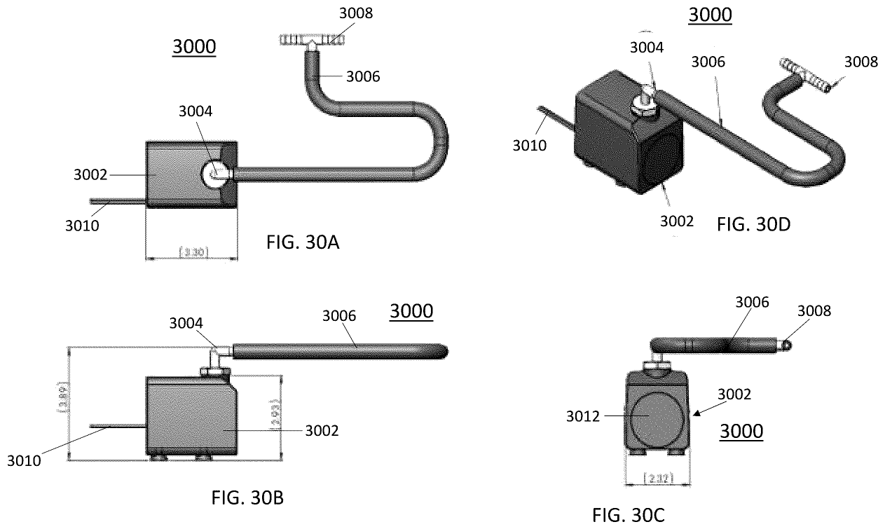

FIG. 30A illustrates a top view of pump assembly 3000 (pump device 118 of FIG. 1) in accordance with some embodiments of the present specification. FIG. 30B illustrates a side elevation view of pump assembly 3000. FIG. 30C illustrates a front elevation view of pump assembly 3000. FIG. 30D illustrates a perspective view of pump assembly 3000. A power cable 3010 connects a pump 3002 to a power source (electrical receptacle 2718 of FIGS. 27A and 27C). In some embodiments, power cable 3010 interfaces with the electrical box 2700 of FIGS. 27A to 27C, as described earlier. In some embodiments, pump 3002 operates at 25 Watts 400 GPH, 120V AC. An adapter 3004 with approximately 0.5 inch diameter on one end, is attached to pump 3002, and with approximately 0.25 inch diameter on the other end, is attached to a tubing 3006. A vented opening 3012 is configured on a front face of pump 3002 to enable intake of fluid in the reservoir in which pump 3002 is submerged. The illustration of FIG. 30C shows a circular opening 3012, which can be of any other shape and/or size, in different embodiments. Tubing 3006 is a hollow flexible tube with an internal diameter of approximately 0.25 inch and an external diameter of approximately 0.5 inch. The other end of tubing 3006 is connected to a tee (a T-shaped adapter) 3008 enabling the two arms of tee 3008 to further connect to tubings that extend upwards on the towers. A single tower system embodiment, would not include a tee, and comprises a straight connector that connects pump 3002 to the single tower. Additionally, in embodiments comprising multiple towers (more than two), tee 3008 is replaced with an attachment that provides multiple branches to connect each tower. In an embodiment, pump 3002 has a depth of approximately 3.3 inches, a height of approximately 2.93 inches that extends up to 3.89 inches when adding the height of adapter 3004, and a width of approximately 2.32 inches.

### Positioning of Water Level Sensor

FIG. 31 illustrates an assembly 3100 of a reservoir tank 3102 fitted with a reservoir lid 3104 (lid assembly 500 of FIGS. 5A to 5C) and positioned inside a base box 3106 (base box 1700 of FIGS. 17A to 17E) connected to bottom of a dual tower unit 3108, in accordance with some embodiments of the present specification. A level sensor assembly (assembly 508 of FIG. 5A and assembly 2800 of FIGS. 28 to 28C) is attached to a bottom surface of lid 3104. Level sensor assembly extends vertically downwards into reservoir tank 3102 that is configured to hold fluids including water. The assembly comprises a float 3110 configured around a vertical threaded nylon standoff (threaded nylon standoff 2806 of FIGS. 28 to 28C) that passes through the center of the float 3110. Additionally a magnet 3112 (magnet 2804 of FIGS. 28A to 28C) rests on top surface of float 3110 such that the vertical nylon standoff passes through the centers of both—float 3110 and magnet 3112. Float 3110 and magnet 3112 are held in a correct X/Y position by the vertical nylon standoff that passes through their centers. A vertical axis 3114 defined by the vertical orientation of the vertical nylon standoff and central to the centers of float 3110 and magnet 3112 provides a reference to which float 3110, magnet 3112 and a reed switch 3116 (switch 508 of FIG. 5A and switch 2708 of FIG. 27A) are all aligned. Reed switch 3116 is positioned inside an enclosure of electrical box 3118 (box 2700 of FIGS. 27A to 27C) attached to bottom of base box 3106.

A pump assembly 3120 (pump assembly 3000 of FIGS. 30A to 30D) is positioned inside reservoir tank 3102 such that pump assembly 3120 rests at the bottom of tank 3102 inside the fluid contained within. Float 3110 is a buoyant “donut”-shaped foam that floats on the surface of a level 3124 of the fluid within tank 3102. As fluid level 3124 decreases inside tank 3102, float 3110 moves closer towards the bottom of reservoir tank 3102. A downward movement of float 3110 is accompanied with the downward movement of magnet 3112 attached to top surface of float 3110. During the downward movement facilitated by decreasing level 3124, magnet 3112 eventually reaches within a range 3122 that activates reed switch 3116. Range 3122 is, in some embodiments from 1 to 4 inches vertically above and extending from reed switch 3116 towards the level sensor assembly. When magnet 3112 is within range 3122, reed switch 3116 activates and turns the power supply to operate pump assembly 3120. Pump assembly 3120 operated to pump water supply and fill reservoir tank 3102. Reed switch 3116 is able to sense the magnetic field put off by magnet 3112 resting on top of float 3110.

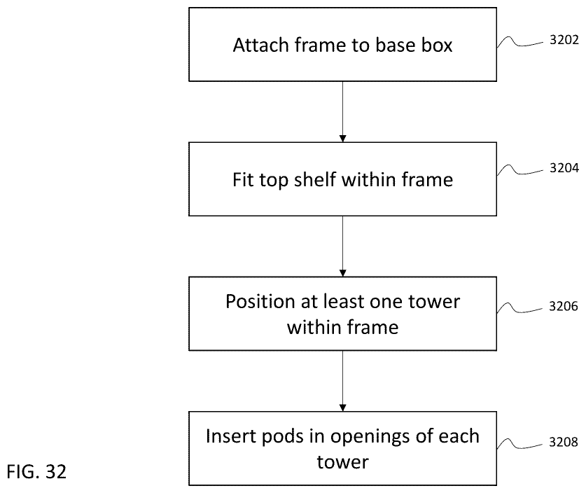

While the above embodiments have been described in context of a two-tower assembly (a tower assembly comprising two tower units), these embodiments and appropriate modifications can be applied to a single tower assembly (a tower assembly with a single tower unit) and assemblies with more than two tower units. FIG. 32 is a flow chart illustrating an exemplary process of assembling the vertical arrangement of plant cultivation in accordance with some embodiments of the present specification. The various components of the tower assembly are assembled together with the help of different kinds of screws. At step 3202, side structure assemblies (FIGS. 10A to 10D) are attached to two opposite sides (left and right) of the base box (FIGS. 17A to 17E). The side structures are attached so that the base box is fixed in a horizontal plane above the ground level, allowing some space between the bottom surface of the base box and the ground surface. Once the side structures and the base box are attached, the side structures can stand upright, enabling attaching of the top shelf assembly (FIGS. 13A to 13D). At step 3204, the top shelf assembly is attached to the side structures such that a top horizontal edge of the vertical shelf panel of the top shelf assembly is aligned between the top rear corners of the side structures. The side (left and right) edges of horizontal shelf panel of the top shelf assembly reach the inner surfaces of the side structures on both sides. Once the top shelf is assembled, the intermediate structure brought together with the side structures, the base box, and the top shelf, can be positioned on a wall. The rear surface of the top shelf assembly is positioned against the wall and screws are used to drill through the vertical shelf panel of the top shelf assembly and into the wall, to attach the intermediate structure to the wall.

A reservoir is then dropped into the base box and positioned towards the rear side inside the base box. The pump (FIGS. 30A to 30D) is placed inside the reservoir so that its tubing extending from the pump's adapter to the Tee is directed towards the rear side of the base box. The pump's power cable is also directed towards and through the back panel of the base box to interface with the electrical receptacle provided at a rear side of the electrical box (FIGS. 27A to 27C) which is attached to the bottom surface of the base box. Suction cups at the base of the pump are firmly fixed to the internal bottom surface of the reservoir which is made from plastic. The reservoir lid (FIGS. 5A to 5C) is installed over the reservoir so that two of its grommets, which are aligned along its rear edge, are positioned proximate the rear side of the reservoir. Tower drains (FIGS. 23A to 23C) are placed directly above the rectangular cutouts (see FIGS. 18A and 18B) so that the cylindrical pipes of the tower drain assemblies pass through the rectangular cutouts and fit into the two circular grommets positioned in and near the rear edge of the reservoir lid.

Finally, at step 3206, the tower units (FIGS. 2A to 2D) are positioned, one after the other in case of a two or a multi-tower assembly. Each tower unit has a first wall and a second wall in continuation with and at an obtuse angle to the first wall. Further each tower unit includes spaced multiple openings vertically aligned in a single column on each of the first side and second side, wherein the multiple openings on the second side are staggered relative to the multiple openings on the first side. A tower unit's bottom edge is first placed over the corresponding tower drain assembly so that its tubing falls into the cylindrical pipe of the drain. The top edge of the tower unit is tilted at an angle while positioning the bottom edge of the tower unit into the tower drain assembly. Subsequently, the top edge is straightened until the two strike plates (Detail B, FIG. 2D) on the back of the tower unit magnetically clasp to the brackets (magnetic catches) on the underside of the horizontal shelf panel of the top shelf assembly (FIGS. 13A to 13D). This process is repeated for the other tower unit, of the two-tower assembly.

At step 3208, a pod is inserted into each spaced opening of each tower. The pod is configured to hold a grow block adapted to cultivate a plant. Each pod is oriented at an acute angle relative to a vertical axis of the tower.

Grow lights (see glow light 11 of FIG. 1) include LED lights that are secured to the side structures with LED clips and screws as shown in FIG. 1. The side structures are pre-drilled with holes to receive the screws. The LED lights are secured with at least two clips each on the frames of both sides of the tower assembly. A base of each light is plugged with individual LED cables that are connected to the electrical box (FIGS. 27A to 27C) beneath the base box assembly (FIGS. 17A to 17E).

Tubing emanating down from each tower unit are pushed and attached to the tee fitting of the pump inside the reservoir. The ribs of the Tee fitting are configured to tightly grip the inner walls of each tubing.

The flow port assembly (FIGS. 26A to 26C) is installed by sliding it between the side structures, below the tower units, and above the base box assembly, such that the oval-shaped opening in the lower cover panel is aligned with the circular fill port (the circular grommet proximal to the front edge) in the reservoir lid (FIGS. 5A to 5C) below it.

Water is added to the reservoir after the installation of the tower assembly is completed. In some embodiments, up to three gallons of water is added through the fill port (using the oval-shaped opening). In embodiments, prior to plugging the tower assembly unit to a power source, the toggle switch (see FIGS. 27A to 27C) is toggled, in some embodiments, by flipping the switch from left side to right side. In embodiments where a push-button/circuit board configuration is employed, the main power cord is connected to a power source and the push-button is depressed to power on the unit. The main power cord is used to plug the tower assembly to a standard wall outlet. The sensors inside the reservoir prompt visual indications, such as ‘low water’ indicator light (FIG. 17E) that can be seen near the bottom left corner of the base box in some embodiments. When the light is on, the user is alerted to the need to add water to the reservoir.

The above examples are merely illustrative of the many applications of the system of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A system for plant cultivation in a vertical arrangement, the system comprising:
at least one vertical tower made from a first material, comprising:
a first wall;
a second wall in continuation with and at an obtuse angle to the first wall;
spaced multiple openings vertically aligned in a single column on each of the first wall and second wall, wherein the multiple openings on the second wall are staggered relative to the multiple openings on the first wall;
a plurality of pods wherein each of the plurality of pods is configured to hold a grow block adapted to cultivate a plant, wherein each of the plurality of pods is configured to be inserted into one of the spaced multiple openings, and wherein each pod of the plurality of pods is oriented at an acute angle relative to the at least one vertical tower.

2. The system of claim 1, wherein the first material is steel.

3. The system of claim 1, wherein the first material is a metal.

4. The system of claim 1, wherein the spaced multiple openings are equally spaced.

5. The system of claim 1, wherein the system further comprises a frame comprising:
a first side structure and a second side structure;
a top shelf fitted between, and at the top of, the first side structure and the second side structure, wherein the top shelf comprises at least two magnetic brackets configured to couple to the at least one vertical tower;
a base box fitted between, and at the bottom of, the first side structure and the second side structure, the base box comprising:
a water reservoir; and
a pump, wherein the at least one tower is positioned within the frame between the first side structure and the second side structure, below the top shelf, and above the base box.

6. The system of claim 5, wherein the first side structure and the second side structure comprise at least one light coupled to each of the first side structure and the second side structure.

7. The system of claim 5, wherein the at least one tower comprises a tubing configured to carry water pumped by the pump from the water reservoir up to a top side of the at least one tower.

8. The system of claim 7, wherein the tubing at the top of the at least one tower branches into at least two smaller tubes, wherein one of the at least two smaller tubes is configured to distribute the water from the tubing to the first wall and, wherein a second one of the at least two smaller tubes is configured to distribute the water from the tubing to the second wall.

9. The system of claim 8, wherein said distribution of water to the first wall and the second wall occurs concurrently.

10. The system of claim 5, further comprising a drain positioned at a bottom of the at least one tower, wherein the drain is located above the base box and is configured to open into the water reservoir.

11. The system of claim 5, wherein the base box further comprises a housing comprising electrical components, and wherein the housing is attached to a bottom side of the base box.

12. A method for assembling a vertical arrangement for plant cultivation, the method comprising:
attaching a frame comprising a first side structure and a second side structure, to a base box which is fixed between, and at the bottom of, the first side structure and the second side structure, wherein the base box comprises a water reservoir, a pump, and a housing comprising electrical components that are electrically connected to the pump;
fitting a top shelf between and at the top of, the first side structure and the second side structure;
positioning at least one tower within the frame between the first side structure and the second side structure, below the top shelf, and above the base box, each of the at least one tower comprising:
a first wall;
a second wall in continuation with and at an obtuse angle to the first wall;
spaced multiple openings vertically aligned in a single column on each of the first side and second side, wherein the multiple openings on the second side are staggered relative to the multiple openings on the first side;
inserting a pod into each of the spaced multiple openings, wherein each pod is configured to hold a grow block adapted to cultivate a plant, and wherein each pod of the plurality of pods is oriented at an acute angle relative to the at least one tower.

13. The method of claim 12, wherein the method comprises using screws for the assembling.

14. The method of claim 13, wherein the base box is fixed in a horizontal plane above the ground level, allowing some space between the bottom surface of the base box and the ground surface.

15. The method of claim 12, wherein the top shelf comprises a vertical shelf panel, wherein a top horizontal edge of the vertical shelf panel is aligned between top rear corners of the first and the second side structures.

16. The method of claim 12, further comprising positioning an intermediate structure comprising the frame, the base box without the reservoir and the pump, and the top shelf, on a wall.

17. The method of claim 16, further comprising positioning the reservoir towards a rear side inside the base box.

18. The method of claim 16, further comprising placing a pump inside the reservoir.

19. The method of claim 16, further comprising fixing the pump to an internal bottom surface of the reservoir using suction cups.

20. The method of claim 16, further comprising installing a reservoir lid over the reservoir.

21. The method of claim 12, wherein positioning the at least one tower comprises placing a bottom edge of the at least one tower over at least one drain fitted above at least one cutout within the reservoir.

22. The method of claim 21, further comprising:
tilting a top edge of the at least one tower unit at an angle while positioning a bottom edge of the tower unit into the at least one drain; and
straightening the top edge until two strike plates on a back side of the at least one tower magnetically clasps to an underside of a horizontal shelf panel of the top shelf.

23. The method of claim 12, further comprising securing lights on each of the first side and the second side of the frame.

24. The method of claim 12, further comprising adding water to the reservoir.

25. The method of claim 12, further comprising enabling power supply to operate the vertical arrangement comprising connecting the electrical components to a power source.
